(19) United States
(12) Patent Application Publication
(10) Pub. No.: US 2002/0087716 A1
(43) Pub. Date: Jul. 4, 2002

(54) System and method for transmitting customized multi priority services on a single or multiple links over data link layer frames

(76) Inventor: Shakeel Mustafa, Tustin, CA (US)

Correspondence Address: SHAKEEL MUSTAFA, 24831 Hendon St., Laguna Hills, CA, 92653, US

(21) Appl. No.: 09/729,255

(22) Filed: Dec. 4, 2000

Related U.S. Application Data
(60) Provisional application No. 60/220,491, filed on Jul. 25, 2000.

(51) Int. Cl. G06F 15/16

(52) U.S. Cl. 709/236; 709/230

(57) ABSTRACT

A system and method are provided to simultaneously support a customized multi-priority services that can be used to transmit multi-priority data link layer frames to a destination host using a single or multiple communication links. The scheme does not require to have any pre-assigned bandwidth reservation policy to support multi-priority services on the link(s). The received frames from one or multiple links can be queued into multi-level services as such that the transmitting device, using customized implemented priority schemes, can control the transmission of the outgoing data-link frames on per byte basis. The system processor at the sending device reserves the full control of the link(s) entire bandwidth and has the ability to release and reassign the bandwidth in any byte proportion to the data-link frames of any service at any desired byte boundary. The transmission of any declared low priority data-link frame can be interrupted in real time ‘on the fly’ in order to relinquish the link bandwidth and network resources to any high priority data-link frame ready for transmission. The methodology of the presented scheme is very flexible and can accommodate any number of multi-priority services on multi flavor data link frame environment. Also, the proposed method and system discloses a very unique and innovative technique that can be used to accommodate a diversity of data-link layer protocols simultaneously and concurrently over single or multiple physical layer communication links.

### BACKGROUND OF THE INVENTION

The higher layer protocols carrying diverse user information rely upon data-link layer to exchange information among the plurality of data-link devices. Data link layer is identified as Layer 2 in the OSI reference model that facilitates the exchange of user information encapsulated by the higher protocols between data-link devices. The widely used and most accepted industry standard data-link protocols are Point to Point Protocol (PPP), Frame Relay, HDLC, SDLC in the WAN side, and Token Ring, Ethernet (with different flavors) in the LAN arena. All of these protocols were initially formulated in response to the requirement of carrying data. As the users demand for using multifunctional applications with different transmission characteristics grew these protocols started to show their weakness to fulfill the specific needs of diverse application layer protocols. The data-link protocols historically designed to deliver big chunks of raw data are not well suited to handle and deliver delay sensitive traffic in real time. For example, multimedia applications require that the transmitting data should be delivered with the least delay and a few flip-flops in their payload bits does not cause a major problem. On the other hand, data delivery applications demands that the integrity of the data frames be preserved during the course of transmission. A mere single flip in the payload bit value can lead to discard the entire data segment transmitted by the transport layer. The data frame transmission is well tolerable to jitter and any additional delay. On slow WAN links, low overhead with high payload is another preference of data applications. Multimedia applications relatively transmit small payloads but they are required to carry large protocol overhead conventionally designed to meet data transmission requirements.

Another service degradation factor for multimedia frames comes from the serialization delay introduced by relatively large data frames. If a multimedia application frame arrives at a particular instance when the transmission of a data frame is already in progress, the multimedia frame must wait in the queue until the data frame transmission is completed. A large data frame being transmitted on a slow WAN link (e.g., over a modem connection) can take a significantly long time for transmission. For example, a 512 byte frame size being transmitted on a typical 56 kbps modem can take roughly 40 msec to complete its transmission. A delay sensitive multimedia frame has to wait this long before it can even start its transmission. There is another class of traffic which does not demand the tight requirements of voice or video but directly involves human interaction with computers. A noticeable delay in these applications response time can decreases productivity and may cause frustration. This traffic type relates to applications like X-Windows, Telnet, http (World Wide Web browsing) etc. The human frustration and loss of productivity which may result because of this excessive delay can be avoided by servicing these applications traffic with a certain priority. Also, when congestion causes packets to be dropped, it can result in many resends.

In technical literature different flavors of priority queuing are well discussed and understood. The priority queuing techniques can manipulate the arriving frames according to their defined priority levels generally related to throughput and delay requirements. The priority oriented services techniques tends to impose limitations on maximum transmitted frame size or a maximum interval time in which data bytes belonging to a particular service can be transmitted. For instance, ATM uses limited and fixed size frame, i.e., 53 bytes cell size, in order to switch the transmission of low priority traffic to high priority traffic between adjacent cells. If an ATM cell carrying a lower priority data is being transmitted ATM service must wait to finish cell transmission before switching to a cell containing high priority data. Also, at least 53 bytes of minimum data must be available in an ATM cell before it can commence its transmission. If the user application layer data that needs to be transmitted is less than the required minimum bytes then the padding bytes are added in the payload at the ATM Adaptation Layer (AAL). In essence the ATM service does not provide a way to switch between a data frame of one service to another ‘on the fly’. The queuing techniques that rely upon assigning specific time slots for multiple services tend to waste bandwidth if a specific service frame is not available for transmission during that particular time slot.

U.S. Pat. No. 5,878,120, filed on Feb. 24, 1997 exhibits these techniques for supporting simultaneous voice and data modes. The scope of the mentioned invention is limited in the regard that it discusses only two services, i.e. voice and data services. An ongoing data transmission is interrupted using special character to start the voice transmission. In its essential limiting sense the aforesaid invention does not support multi-priority services on a transmission link. In addition to that, the scope of the invention is limited to using a single communication link.

Historically, IBM SNA suite of protocols is used to carry data among mainframes. It is estimated that in data communication networks over 50% of the total traffic flow originates from SNA based network architecture. The SNA architecture typically relies upon HDLC/SDLC protocols which traditionally use dedicated or leased lines connections for communication. Once a dedicated link is configured for the said protocols it is not easy to run any other data-link layer protocol concurrently on the same link in its native format. IDC survey shows that roughly 70% of all the network connections are established over the leased lines which predominately carry SNA protocols for data communication. The effective bandwidth utilization by the SNA protocols over a leased line is very low. The majority of the time the leased line remains idle and it is not used by active data communication. It is quite possible to utilize the bandwidth resources of the leased lines for the other type of communication services based on different data link protocols when the line is not used by the conventional SNA traffic. With a proper implementation of priority services it can be ensured that the presence of other type of communication services on the link do not effect the communication parameters and behavior of the SNA traffic.

Having said that, there is need for a particular technique that can interrupt the transmission of a low priority frame in the presence of a high priority frame in real time at the data link communication layer. Also, the technique should be completely transparent to the intermediate data link devices which can be unaware of the working methodology of the preferred embodiment. In other words the existing data link network infrastructure does not need to be modified for the use of this technique. Also, a technique that can support customized priority services to the data link frames transmitted simultaneously over single or multiple communication links where the involved link(s) exhibits different and diverse network characteristics. The different and diverse characteristics of network elements may include, but are not limited to different link bandwidth, variable and fixed delay characteristics, different flavors of LAN and WAN data link protocols being used between different links. Also, the preferred embodiment can provide a way to augment the bandwidth available to a communication device through plurality of diverse data link layer connections. Further, the technique can dynamically allocate and manage, among different priority service classes, the available bandwidth of its data link layer communication connections. Also, a method and system that can accommodate diverse data link protocol, e.g., HDLC/SDLC, Frame Relay, PPP/SLIP etc. concurrently on the same communication link.

### SUMMARY OF THE INVENTION

A system and method to support customized multi-priority services over data link layer frames using single and multiple communication links. The customized multi-priority algorithm uses customized feedback for communication requirements to generate traffic priorities of outgoing data link frames over single or multi-communication links such that the transmission of the frame on a byte by byte basis is dynamically coupled with the steady and variable network conditions. The multi-priority algorithm can be coupled with the application behavior parameters and can dynamically adjust the priority levels to ensure the proper required transmission of data. Also, the service priorities can be strictly defined by the user's direct input. For example, the data link frames originating from a particular station can have the highest priority during a certain time and then the priority level can be dynamically reduced at during another time. Bulk traffic is normally declared as low priority traffic. Even this kind of traffic can suffer from too much competition. A file transfer can be aborted after excessive delays experienced by the transport layer as a result of fierce competition among high priority traffic contenting for the link bandwidth. The scheme provides a way to dynamically adjust and escalate the priority level of an initially declared low priority service to a high priority. By using this approach a small portion of low priority traffic can be sent as a high priority to avoid timeout sessions and retransmits. The remainder of the data for this traffic class will be sent as best effort or according to its assigned priority level.

It is therefore an object of the present invention to present a method and system that can interrupt and seize, if desired, further transmission of any type of data link frame being transmitted on any single or multiple links at any frame byte boundary in real time.

Another object is a method that can be used with any data link layer frame to achieve all the capabilities of the presented invention.

Yet another object is a method and system for transmitting data link frames with the presented scheme as such that any intermediate data link switch or switches are not required to be aware of the presented scheme in order to pass through the data link frames to another data link device which is aware of presented scheme.

It is further an object of the present invention to receive multi-priority data link frames over single and multiple communication links and then re-assign the priority service, if desired, and transmit the frames in a different data link format, if desired, to an outbound single or multiple communication links.

An even further object of the present invention is to provide a technique that can terminate the further flow of a data link frame using this scheme at any data-link device. Any further outbound communication from the said data link device to any other data-link device can be in the native data-link format.

Still another object of the present invention is to use a unique sequence number within a data link frame being transmitted on single communication link that can represent a distinct class of service exclusively based on any single or multiple communication parameters defined by a hardware equipment or a software application. The said communication parameter(s) can include any identification that can be used to distinguish one data-link frame from another. A unique service class, once defined, is identified by an assigned sequence number in a data-link frame.

Still yet another object of the present invention is to use a unique sequence number range within a data link frame being transmitted on a single or multiple communication links that can represent a distinct class of service exclusively based on any single or multiple communication parameters defined by a hardware equipment or a software application. The distinct sequence range represents a unique service class and the sequence numbers within the defined range can be used to identify multiple segments of a single frame transmitted over multiple links to a destination. The said communication parameter(s) can include any identification that can be used to distinguish one data link frame from another.

Yet another object of the present invention is to present a scheme that can include cut-through mechanism for faster transmission of a data link frame through a data link switch. During the course of transmission in the cut-through mode, the scheme still presents a technique to interrupt the passing data link frame ‘on a fly’ in order to relinquish the link bandwidth for a higher order priority frame.

Still another object of the present invention is to utilize a scheme that can effectively and simultaneously use all the available bandwidth of all the communication links available between sending and the receiving data link devices. The scheme will dynamically re-adjust the different data link frame sizes being transmitted on the diverse communication links in response to the changing network communication characteristics, e.g., delay, throughput, etc. By implementing the proposed strategy the scheme ensures to maximize the simultaneous use of all the available bandwidth over multiple links thus achieving higher throughput.

Still another object of the present invention is to provide a unique way of selecting and prioritizing multi service classes based on the user and application defined parameters. These defined parameters can include any fixed or variable criteria which may depend on other dynamic functions. A weighing priority number, Wi, is calculated at different time intervals to determine a service class with the highest weighing priority number which gets permission to transmit its data for the said interval.

Yet another object of the present invention is to provide a method and system that can be used to accommodate a diversity of data-link layer protocols simultaneously and concurrently over a single or multiple communication links. Using the proposed method and system different data-link layer frames, e.g., HDLC/SDLC, Frame Relay, PPP/SLIP etc can not only concurrently co-exist on the same communication link but also utilize all the available bandwidth resources of a single or multiple communication links simultaneously to carry a diversity of data encapsulated in the said frames.

Still another object of the present high level flow diagrams related to the transmit, receive, service, etc. algorithms that explain different aspects of the preferred embodiment.

It is another further object of the present invention to describe the scope and implementation of the preferred scheme with illustrations and examples. Also, the related diagrams describe some user applications that can be enhanced and improved through implementing the claimed functionality of this embodiment.

These together with other objects of the invention, along with the various features of novelty which characterize the invention, are pointed out in this disclosure. For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 illustrates typical data link frame formats widely used in LAN and WAN environment;

FIG. 2 shows the position of a proposed sub-framing byte added at the end of the user data and before the CRC field in a standard data link frame format;

FIGS. 3A and 3B represent system diagrams illustrating the flow of data link frames through a network consisting of multiple data link switches;

FIG. 4A illustrates an example of creating multiple priority service classes and assigning each service class a specific range of sequence numbers;

FIG. 4B illustrates the concept of using more than one byte for sub-framing purpose which increases the range of sequence numbers available for service class identification;

FIG. 5 shows the reserved position of the proposed sub-framing byte in reference to a standard frame relay format;

FIGS. 6A and 6B are the diagrams illustrating the concepts and preferred methods of segmenting a data link frame into sub-frames;

FIGS. 7A and 7B is an illustration of using cut-through scheme for a data link frame transmission and then interrupting the said frame to pass higher priority frames;

FIG. 8 is a diagram showing the process of building the original transmitted frame through assembling a certain number of received sub-frames;

FIG. 9 is a diagram illustrating the process of building the original frame relay format transmitted frame through assembling a certain number of received sub-frames;

FIG. 10 is a diagram illustrating the process of segmenting a large frame belonging to a service class into multiple sub-frames such that the sequence number range assigned for the service class is very limited;

FIG. 11 is a block diagram schematically representing the transmission process of the data link frames to the end host through a single communication link;

FIG. 12 is a block diagram representing the transmission processor of data link frames to the end host utilizing two or more communication links;

FIG. 13A illustrates the process of segmenting a large data link frame into multiple sub-frames of certain data proportion;

FIG. 13B is a network diagram schematically representing the transmission flow of data link sub-frames through multiple networks;

FIG. 14A illustrates the internal system buffers architecture for storing and processing the data link frames;

FIG. 14B is an exemplary depiction for assigning different priority levels for the data link frames contenting for the link bandwidth;

FIG. 15A is the schematic representation of a process flow chart designed to determine and enforce frame transmission priority;

FIG. 15B is a flow chart for calculating the CRC value dynamically to be used in the procedural process of interrupting and properly terminating the transmission of a data link sub-frame;

FIG. 15C is a depiction of bytes being transmitted of a data link frame. The illustration relates to FIG. 15B for a better understanding of the said flow diagram;

FIG. 15D represents the last step of the process flow diagram shown in FIG. 15A;

FIG. 16A is a block diagram illustrating the receive process of data link frames over a single communication link;

FIG. 16B is a block diagram illustrating the receive process of data link frames over two or more communication links;

FIG. 17 is the process flowchart for receiving and verifying the integrity of the data link frames;

FIG. 18 is the process flowchart for assembling the received data link sub-frames and then reproducing the original transmitted frame for a service class;

FIG. 19A is an illustration to explain with an example the reassembling procedure for the sub-frames received over a single communication link;

FIG. 19B is an illustration to explain with an example the reassembling procedure for the sub-frames received over two or more communication links;

FIG. 20A is a network diagram illustrating the steps involved in segmenting a large packet to meet the MTU (Maximum Transmission Unit) requirements of a device interface;

FIG. 20B depicts the process of handling multi-priority frames on the LAN side and then forwarding the frames over the WAN side in accordance with the spirit of the preferred embodiment;

FIG. 21 is a flowchart describing the procedure for interrupting and segmenting a large data link frame for implementing the operations of FIG. 20A;

FIG. 22 presents the hardware implementation of the proposed method and system to connect diverse networks over multiple dedicated communication links;

FIG. 23 also illustrates the hardware implementation of the proposed method and system to connect diverse networks over a plurality of data link layer networks;

FIG. 24 is a schematic representation of a general flow chart for utilizing a single DLCI to accommodate multi-priority frame services over a single or multiple frame relay networks;

FIG. 25 shows the hardware implementation of the proposed method and system in a network environment where a variety of data link protocols are transmitted concurrently over a single or multiple communication links;

FIG. 26 demonstrates a practical example of using multimedia application in the Internet environment according to the methods described for the preferred embodiment;

FIG. 27 illustrates an alternative sub-framing format that can be used to segment a data link frame;

FIG. 28A depicts yet another sub-framing format that can be used to segment a data link frame to achieve a low overhead; and

FIG. 28B shows a suggested sub-framing byte format to be used in the scheme presented in FIG. 28A;

### DETAILED DESCRIPTION OF A PREFERRED EMBODIMENT

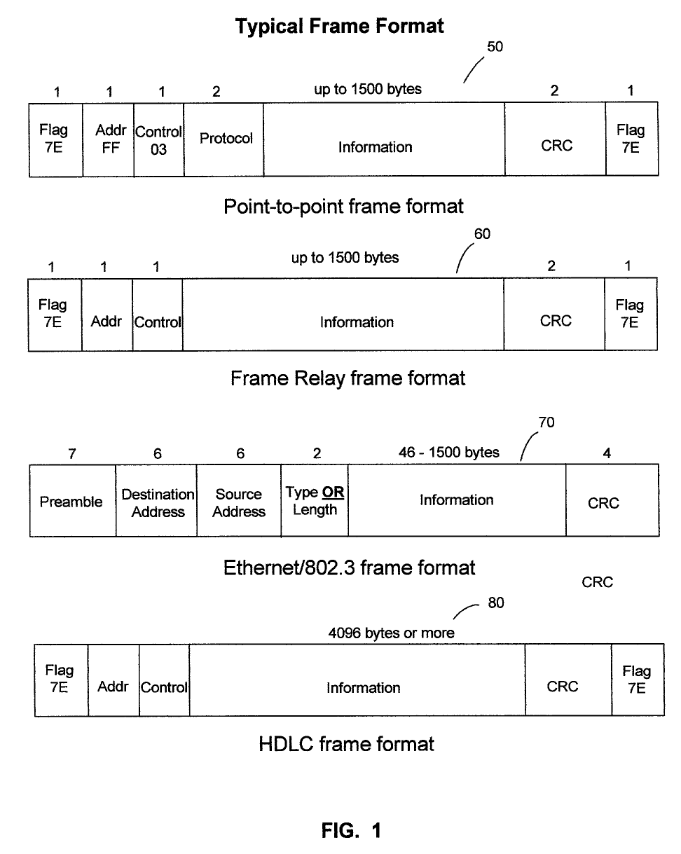

FIG. 1 are the diagrams that illustrate typical frame formats being normally used by the communication devices at the data-link layer. A data-link frame is typically bounded between two flags. A unique byte value of 7E is used to define the presence of flags at the start and end boundaries of a data-link frame. The typical LAN based protocol e.g., Ethernet, Token Ring, use preamble bytes to announce the start of the frame. Regardless of these differences to defined the boundaries of the frames, all data-link protocols have a unique similarity of using the CRC bytes at a well defined position from the ending frame boundary. The CRC bytes uniquely occupy a certain position before the ending flag or preamble. The receiving device is programmed to search for the CRC bytes occurrence at certain byte positions before the ending boundary.

For the purpose of illustration the preferred embodiment will be discussed in the reference of data-link frames which use flags to delineate frame boundaries. The scope and coverage of the present invention, nevertheless, equally apply to all other type of frames where the position of the CRC bytes are uniquely identifiable with reference of any demarcation defined in the frame.

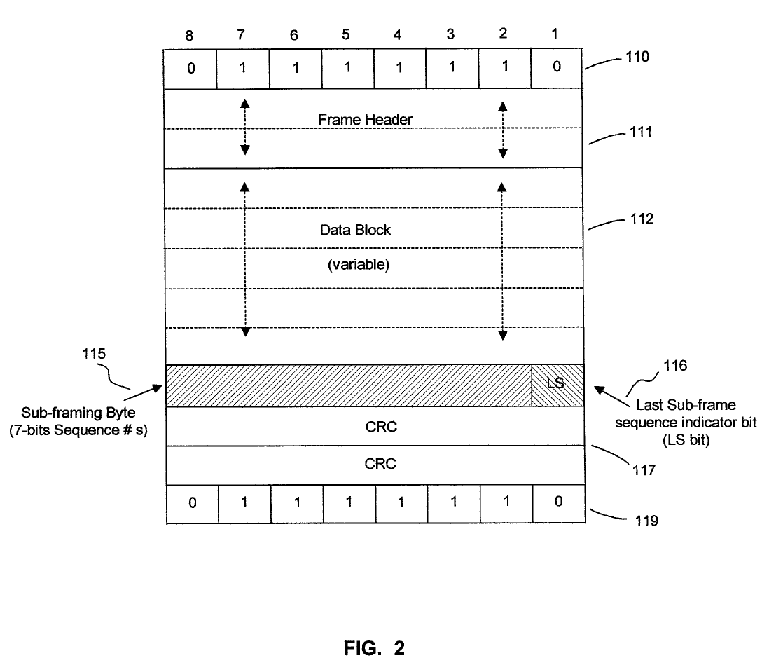

In this regard FIG. 2 shows a typical data-link frame structure illustrated in byte format. The first 8-bits 110 is the opening flag (7E in Hex), the next variable bytes field 111 represents the frame header and 112 are the variable date field. Before the two CRC bytes 117 a single or multiple bytes adjacent to CRC bytes field can be reserved. The position of the reserved byte(s) can be uniquely identified by the data-link devices as adjacent to the CRC bytes. The interpretation of the information contained in these bytes is explicit and only delegated to the dedicated data-link device participating together in a communication link. The intermediate data link devices which perform the transient operation for data link frames will consider the presence of the sub-framing byte, for all essential purposes, as part of user data carried by a data link frame with the correct value of the CRC which follows the sub-framing byte of the said frame. The intermediate data link devices tend to perform CRC check to verify the integrity of the frame before they forward the frame to the next data link device which can either use the same data link frame format or a different frame format. Since the attached CRC field of the received frame is calculated by the source data link device with the inclusion of sub-framing byte, any intermediate device which performs frame integrity check would declare the frame as a valid frame.

Referring back to FIG. 2, a single byte 115 is shown in the shaded portion, before the CRC bytes 117 is assigned the status of reserved byte. User specific data can not be put into this reserved byte. The bits information herein contained can only be exclusively interpreted by the participating data-link devices. This shaded byte called sub-framing byte constitutes two parts; a 7-bit part assigned for sequencing numbers and a 1-bit part assigned as last sub-frame indicator bit (LS bit) 116.

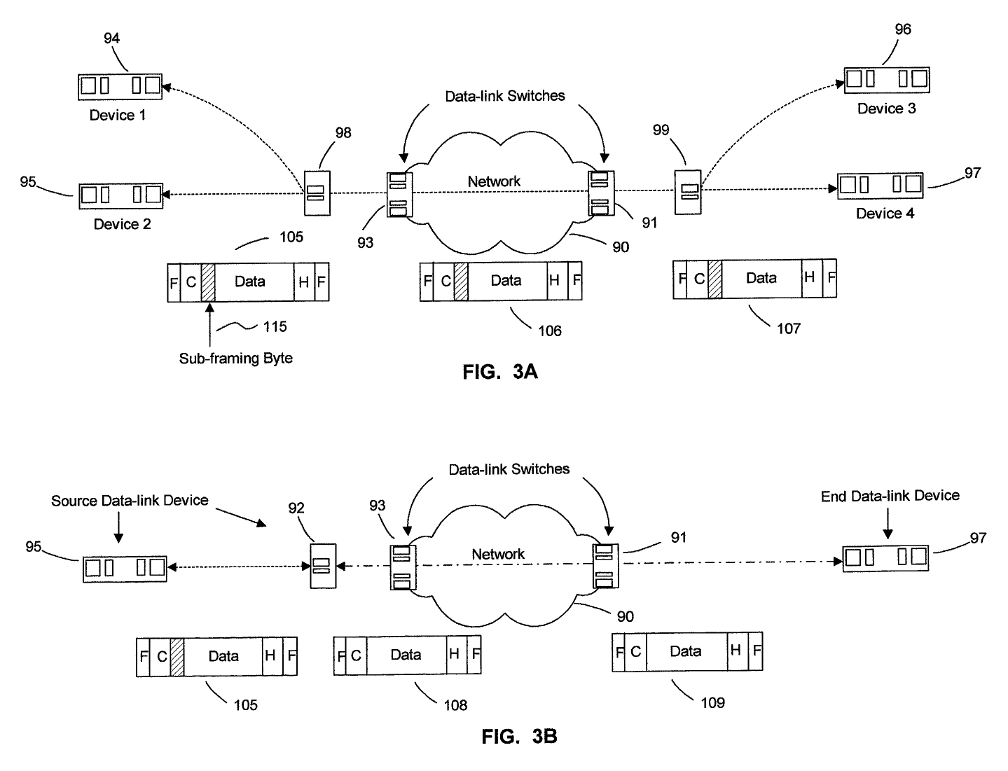

Turning now to FIGS. 3A and 3B which illustrate a link connectivity between various data-link devices in a network. Two source data-link devices 94 and 95 in FIG. 3A communicate with the data link device 98 using a data link protocol with the presence of a sub-framing byte in their frame format. The device 98 can prioritize the traffic being received from the device 94 and device 95, and forward the traffic consisted of data link frames through two or more data-link switches in the network 90. As mentioned earlier, the presence of the sub-framing byte 115 in the sub-frames 105, 106 and 107 will be transparent to any intermediate data link switch that needs to perform any integrity check. Once the data link frames arrive at the destination devices 96 and 97 the related information contained in the sub-framing byte will be processed and the sub-framing byte will be removed from the data link. The detailed procedure is well explained in the following sections of the preferred embodiment. Before establishing any communication exchange all the end devices involved in the dialogue have to mutually agree upon a pre-defined set of rules required to interpret the bits in the sub-framing byte 115. This “communication understanding” can either be configured statically on each device or a proprietary link control protocol can dynamically exchange the required information to configure this understanding among the participating communication devices. It is not necessary for all the intermediate devices to understand the interpretation of the sub-framing byte(s). Only the participating devices need to know the interpretation. In this regard the intermediate devices 93 and 91 are completely oblivious to the sub-framing byte presence in a passing data link frame and interprets the byte(s) as the part of user data. The data-link frame 115 with the reserved sub-framing byte in it transparently passes through intermediate data-link switches 93 and 91.

FIG. 3B illustrates another configuration where the source data link device 95 establishes connectivity with device 92 and the interpretation of the sub-framing byte is restricted between the device 92 and device 95. The frame 105 transmitted by the device 95 contains the sub-framing byte. Its pear device 92 receives the frame and executes the instruction in the sub-framing byte. The device 92 strips off the sub-framing byte and recalculates the new CRC value to be appended in the frame. The new frame 108 without the sub-framing byte is then transmitted in a native data-link format to the switch 93. All the remaining data-link devices in the network accept and process the frame in its native form.

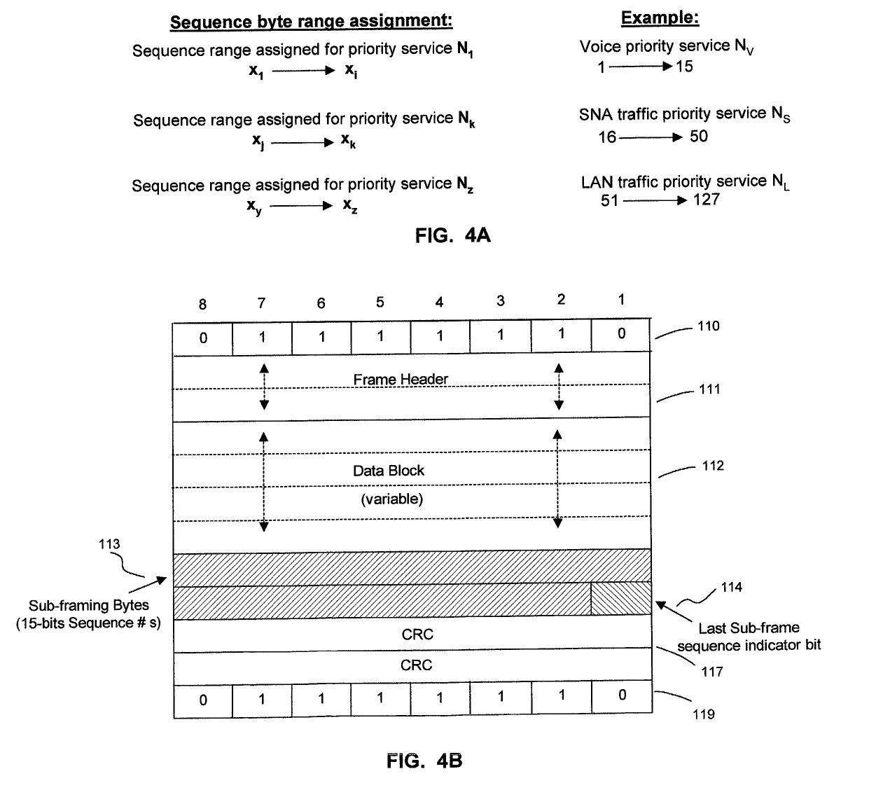

As previously mentioned in FIG. 2 the sequence part 115 consisted of 7-bits is used to assign unique sequence numbers to the frame. With 7-bits, 128 unique binary numbers are possible. This sequence number range is further divided into groups. Each group uniquely identified by an assigned sequence range represents a service class being carried over a data link layer. FIG. 4A explains this concept visually with the help of an example. Service classes N₁ to N_{z} are uniquely identified by a range of sequence number assignments. The service class N₁ contains a sequence range x₁→xᵢ, Nₖ has xⱼ→xₖ, and N_{z} contains x_{y}→x_{z} sequence range.

As an illustration the three class of services, voice, SNA, and LAN services are configured on data link layer. The sequence range for voice priority service, Nv, is assigned from 1→15, for SNA, Ns, 16→50 and for LAN class of service, N_{L} is 51→127. The source data link device uses the designated sequence range information of each service class to generate the proper sub-framing byte value and appends this value in the related class of service frames.

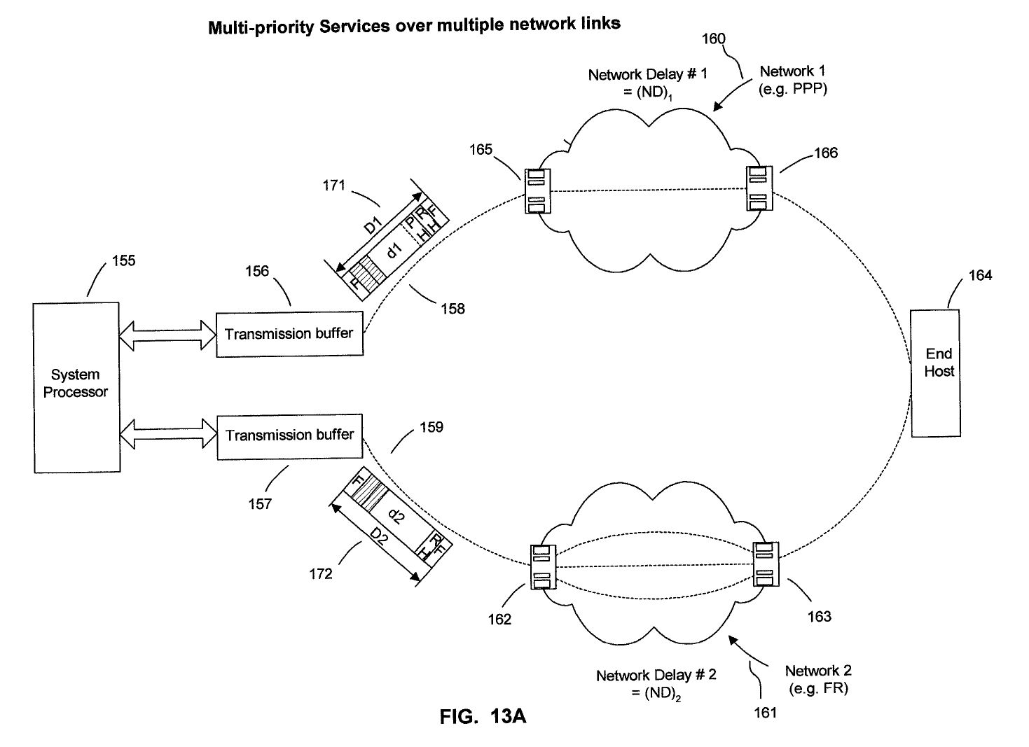

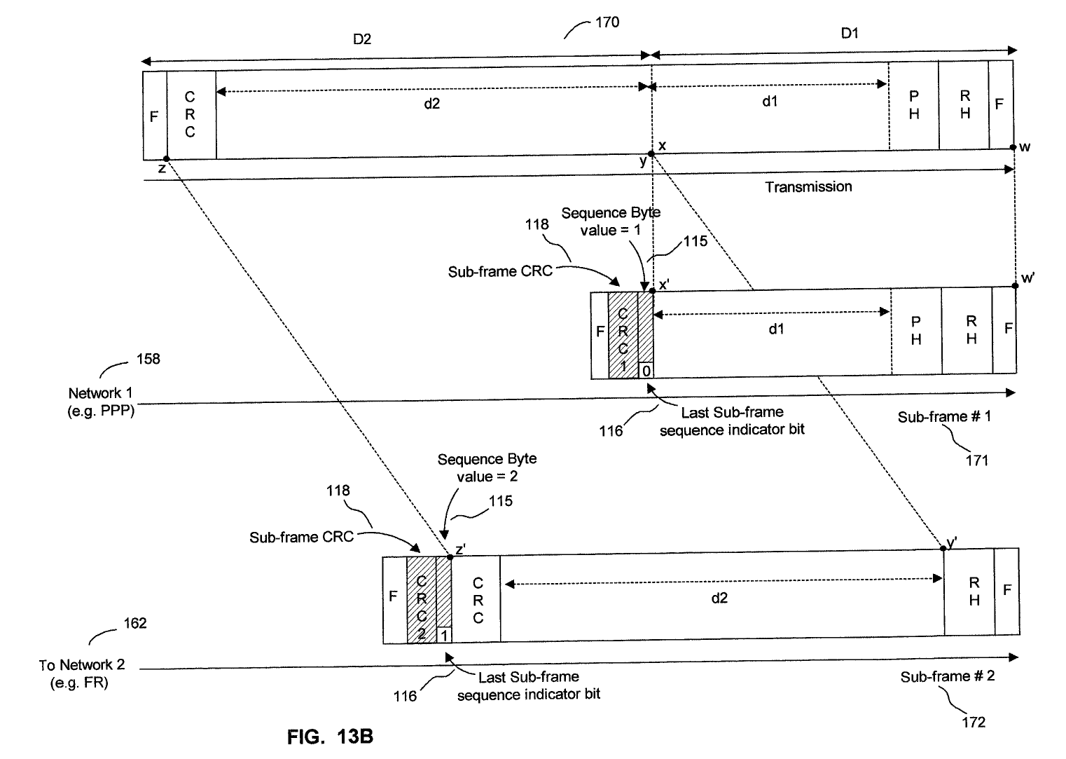

FIG. 4B shows the possibility of increasing the sequence number by adding the extra 8-bits of the next adjacent byte in the sequencing numbering scheme. The resulting 15 bits can yield a permutation of 2¹⁵=32768. The two bytes reserved for sub-framing can cover multiple priority services and each service can contain a wide sequence range. The need for acquiring a wide range of sequence number for a service class will become apparent with the related discussion presented in reference of FIG. 13B.

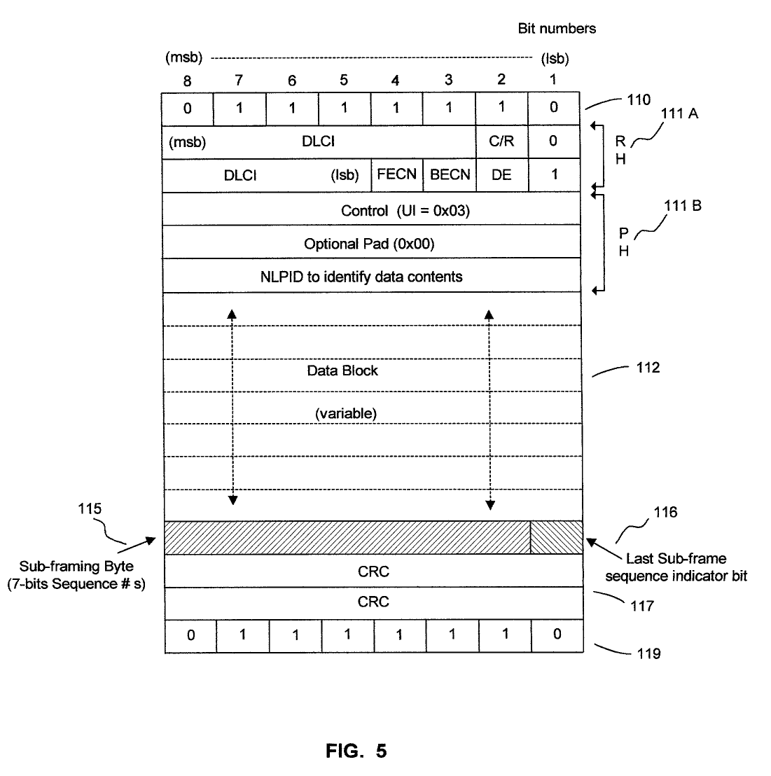

Referring to FIG. 5 which illustrates the use of a sub-framing byte in a typical Frame Relay format frame. The opening flag byte 110 has a bit pattern of 7E in hex. The following two bytes 111A represent the Routing Header (RH) of the frame which includes the DLCI number and other standard bit values typically used in a frame relay format. The group of bytes following the RH are the Protocol Header (PH) bytes 118 and this field commonly contains the communication protocol headers in the first several octets of the frames. IETF, for example, recommends three specific values, i.e., 0x03, 0xAF and 0xFB, in the first byte of every frame as the control field. A certain pre-defined byte value that follows the control field is used to identify different flavors of the protocols IDs carrying the user data. The information embedded in the PH is not used in the routing decision of the frame but it is used by the higher communication layers to identify uniquely the data associated with each of the protocols.

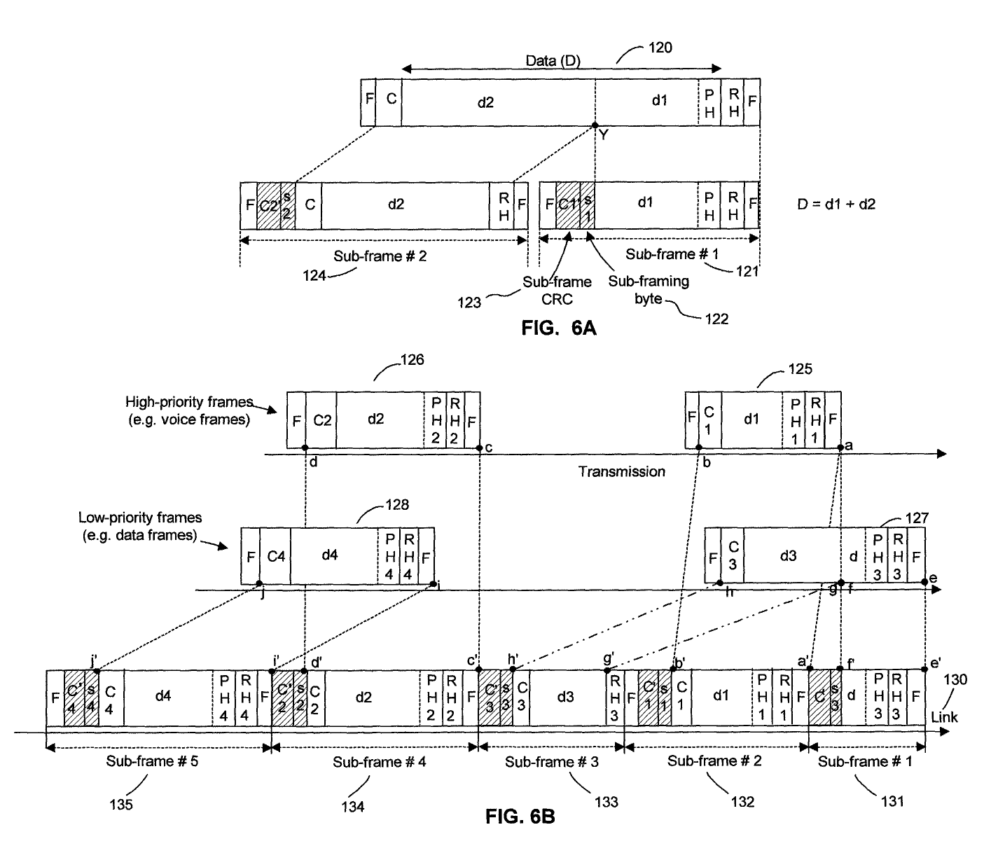

FIGS. 6A and 6B demonstrate procedures that use the sub-framing byte information to partition a data-link frame into multiple sub-frames. The “real time” partitioning of a low priority service frame being transmitted can be used to interrupt the transmission of the said frame in the event a high priority frame needs to be transmitted. With the presented procedure a frame can be partitioned into multiple sub-frames, each containing a segment of the original frame. The size of the resulting sub-frames can be completely different from each other. In addition, the presented scheme does not require that the sending and the receiving data link devices have to mutually agree upon any minimum or maximum sub-frame size. Also, the interruption procedure on a frame can be invoked at any byte boundary of a frame being transmitted.

FIG. 5A shows a typical data link frame 120 which needs to be segmented into multiple sub-frames. For illustration purposes, the frame 120 is segmented at a byte boundary Y into two sub-frames, sub-frame #1, 121, and sub-frame #2, 124. Using the following procedure, the frame 120 can be portioned into any number of sub-frames if desired. Each of the two sub-frames described herein carries a partition of original data of the frame 120. Therefore, sub-frame #1, 121 contains the initial d1 data bytes of the frame 120 and the sub-frame #2, 124 carries the remaining portion of data (d2 bytes +original frame CRC (C field)). Each of the segmented sub-frames represents a complete data link frame that can be independently routed from the other sub-frames in a network. The original routing header (RH) and the protocol header (PH) are carried in the sub-frame #1, 121 whereas sub-frame #2, 124 only replicates the routing header necessary for routing the sub-frame through the network. The 7-bit sequence field of the framing byte contains the initial sequence number from the assigned sequence range of the frame service class. Since the sub-frame 121 is NOT the last sub-frame (remaining segment of the frame yet to come) the LS bit in the sub-framing byte is set to 0. Following the sub-framing byte 122 is the sub-frame 2-bytes CRC field 123 which is calculated over the entire sub-frame including the sub-framing byte value. The next sub-frame #2, 124 contains the remaining data bytes plus the original CRC bytes (C field). The 7-bit sequence part of the framing byte in the said sub-frame contains the next incremental sequence number of the service class. Since the sub-frame #2, 124 contains the last segment of the frame 120, the LS bit value is set to 1 in the sub-framing byte. The sub-frame CRC (C2) is calculated over the entire data portion of sub-frame #2, 124 including the s2 and C bytes present in the said sub-frame. A closing flag (7E) follows the sub-frame CRC (C2′ field).

FIG. 6B demonstrates how this scheme can be used to provide a transmission priority of one service class over the other service class. The FIG. 6B presents two service classes labeled as high priority service and low priority service. As an example, a high priority class may constitute a voice service and a low priority class delivers data services. The frames arriving in the high priority queue need to be transmitted right away as they become ready for transmission. If a low priority frame is being transmitted at that particular time it needs to be interrupted so the transmission of a high priority frame can be started. In this illustration a low priority frame 127 is being transmitted on the communication link 130. At point ‘f’ of frame 127 a higher priority service frame 125 becomes ready for transmission. The system processor invokes the interruption procedure as described in reference of FIG. 6A and halts any further transmission of frame 127. After injecting the proper sequence byte s3 and CRC byte C′, the communication link makes itself available to start the transmission of the sub-frame 125 at point a′. Because of the interruption of the frame 127, only ‘d’ bytes of the said frame are transmitted at point f of link 130. The sub-frame 125 commences its transmission at the point a′ on the transmission link 130 after a delay equivalent to the serialization delay resulted from inserting the three terminating bytes (1 sequence byte +2 bytes CRC) of the sub-frame #1, 127. For a 64 kbps link speed the serialization delay for three bytes transmission is 0.515 msec. At a higher transmission speed the serialization delay is further reduced, e.g., at a T1 circuit (1536 kbps) the delay is 15.62 usec.

To make a comparison with an ATM link operating at T1 speed a priority cell has to wait on the average of ½ of the duration of 1 cell, 53/2=26.5 bytes before its transmission. The serialization delay for 26.5 bytes at T1 speed is 138 usec. This means that the switching time provided by the present embodiment is almost 9 times less than the ATM. Additionally, the time required to switch a cell belonging to low priority to a high priority is variable and deterministic. Depending upon how many bytes out of 53 bytes of a low priority cell are transferred prior to the start of a high priority cell transmission, the queuing delay for the high priority cell will vary. On the contrary, the present embodiment relies upon a fixed number of bytes to switch between the low to higher priority traffic. Since the transmission speed of the link 130 is known and, also, there are always three bytes used for termination, the serialization delay will be deterministic.

Referring back to FIG. 6B, the transmission of the frame 125 from a-b corresponds to a′-b′ of the sub-frame #2, 132 on the transmission link 130. It should be noted that the original CRC value (C1) of the frame 125 is also carried into the payload of sub-frame #2, 132. Since the frame 125 does not get fragmented the LS bit value in its sub-framing byte, s1, is set to 1. After transmitting the sub-frame #2, 132, the system processor resumes the transmission of the remaining portion of the frame 127 (d3+C3 bytes) left out earlier because of the interruption. To do that the system processor uses the ending flag of the frame #2, 132 as an opening flag for the sub-frame #3, 133 which is going to deliver the remaining portion of the frame 127. The routing header RH3 of frame 127 is duplicated and inserted after the flag. The remaining portion, g-h bytes of 127 is mapped to the payload, g′-h′, of the sub-frame #3, 133. The sequence number of the sub-framing byte is sequentially incremented by 1 and the LS bit value is set to 1 indicating that the present sub-frame contains the last segment of the frame 127. The CRC bytes (C′3 field) calculated over the sub-frame #3, 133 is appended after the sequence byte s3.

To explain further the mechanism of the scheme, refer to the next frame 126 in the high priority queue as illustrated in FIG. 6B. The frame 126 becomes ready for transmission at point c. The system process starts to transmit this frame to link 130 at point c′. Another frame 128 belonging to a low priority service becomes ready for transmission at point i. Since the frame 128 has a low priority over the frame 126 being transmitted, the system process will NOT interrupt the transmission of the frame 126. The frame 126 c-d bytes are mapped to c′-d′ of the sub-frame #4, 134 on the transmission link 130. As described earlier, the frame 126 CRC bytes (C2) are also transmitted in the payload envelope of sub-frame #4, 134. Following the C2 field is a sub-framing byte, s2, which contains the next sequential increment of the higher priority service class. The LS bit of the framing byte of sub-frame #4, 134 is set to 1, indicating that this is the last segment (in this case, the only segment) of the frame 126. The sub-frame #4, 134 CRC bytes (C′2) are calculated over the entire said sub-frame and follows the sub-framing byte s2. The system processor uses the ending flag of sub-frame #4, 134 at i′ as an opening flag for the sub-frame #5, 135. The entire frame 128, i-j, is mapped to the i′-j′ portion of the sub-frame #5, 135 on the transmission link 130. As described earlier, the appropriate values of the sub-framing byte and the said sub-frame CRC bytes follow with an ending flag to complete sub-frame #5, 135.

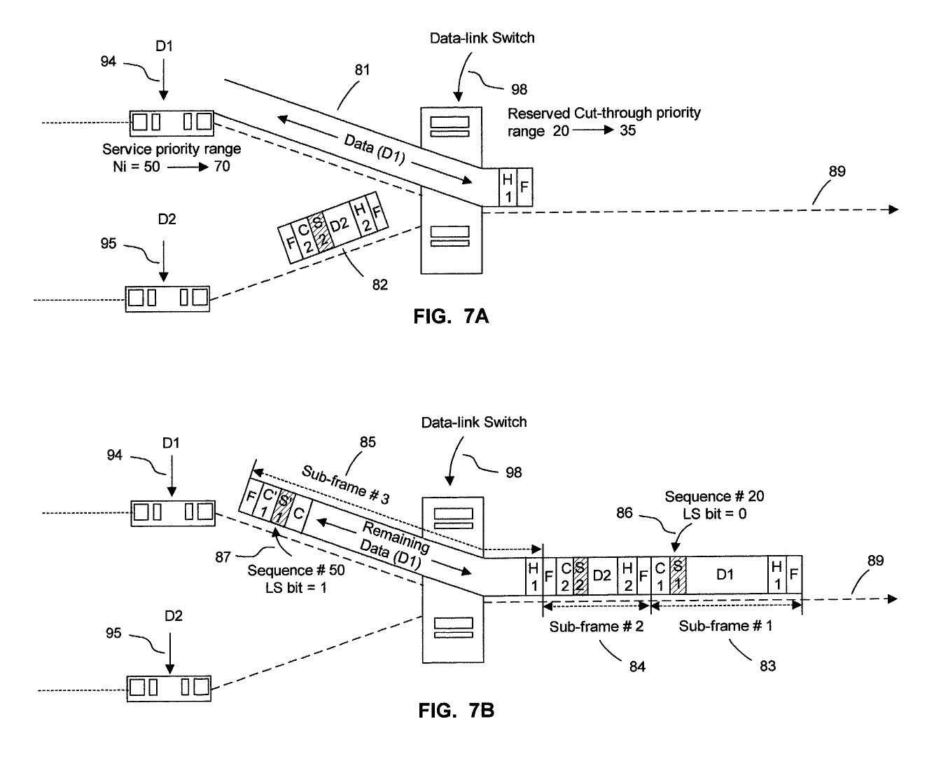

FIGS. 7A and 7B demonstrate a procedure known as “cut-through” in data link frames transmission. In this procedure a received frame can start its transmission over the WAN link as soon as it is received at the switch. The frame switch essentially does not have to follow a store and forward technique to verify the frame CRC value before it allows the frame transmission. The use of this technique greatly reduces the serialization delay associated with the store and forward scheme. All the intermediate data link switches also take the same approach and, generally, forward the received frame to the next switch the moment they receive a frame. The last data link switch on the communication link stores the entire frame, verifies the frame's CRC and if it matches it delivers the frame to the connected data link device(s). The cut-through approach significantly reduces the queuing and serialization delays associated with the store and forward technique.

From the presented discussion so far it may appear that the preferred embodiment may not be able to use the cut-through technique. The following is the problem that may seems to appear for the cut-through approach in the preferred embodiment.

As discussed in the present invention a switch needs to know ahead of time about the proper sequence range of the service class frame being transmitted at the WAN link. In the event the passing frame needs to be terminated to preemptive the link bandwidth to a higher priority frame, the system processor can append the proper sub-framing byte of the passing frame service class and CRC bytes to end the further transmission of the said frame. The problem is that the system processor at the switch would not know the service class of the frame being transmitted and, also, the sequence number until it receives the sub-framing byte information which is at the trailing bytes of the passing frame. This means that a passing frame using the cut-through technique can not provide its sub-framing byte information when the system process needs it.

To circumvent this apparent problem and to utilize the efficient cut-through method in the embodiment, a simple technique can be introduced. The scheme relies upon reserving a certain sequence range specifically divided into one or multiple service classes reserved for the cut-through scheme. A cut-through frame will be assigned one of these defined service classes. If the cut-through frame needs to be interrupted the appropriate sub-framing byte value will be generated through this reserved sequence range of the pre-defined service. The original sub-framing byte value of the cut-through frame, once received by the system processor, will be switched with the sequence range of the reserved class.

FIGS. 7A and 7B illustrate the use and implementation of this technique. As shown in FIG. 7A, a data link device 94 transmits a large frame 81 to the data link switch 98. Since the WAN link 89 is available for transmission the system processor of switch 98 puts the frame 81 right away on the transmission link. A frame 82 with a higher priority is sent to switch 98 by the data link device 95 for transmission. Since the link 89 is being used by the frame 81 the system processor stores the entire frame 82 and recognizes its higher priority level by reading its sub-framing byte. Realizing that frame 82 has a higher priority than the passing frame 81, it invokes the interruption procedures. It generates the proper sequence byte by using the first available sequence number 20 of the reserved cut-through sequence class (20→35) and sets the LS bit=0.

FIG. 7B illustrates the resulting sub-frame # 1, 83, carrying the initial D1 portion of data of the original frame 81 with a sequence number of 20 and the LS bit set to 0 in the sub-framing byte 86. The sub-frame #2, 84, which is inserted through the interruption procedure carries the entire priority frame 82. According to procedures as described in conjunction with the FIGS. 6A and 6B the remaining data of the frame 81 is carried in the sub-frame #3, 85 provided there is no further interruption of the frame 81. As shown in FIG. 7B, the sub-framing byte 87 of the sub-frame 85 which is still being received carries the original sequence number 50 with the LS bit set to 1, indicating the Last Segment of the frame 81. Once this sub-framing byte passes through the switch 98 its sequence number will be changed 21 (next ascending sequence number of the cut-through service class) and the LS bit value will be set to 1. The CRC value of the sub-frame #3, 85, (C′1) will be recalculated by the system processor to reflect these changes.

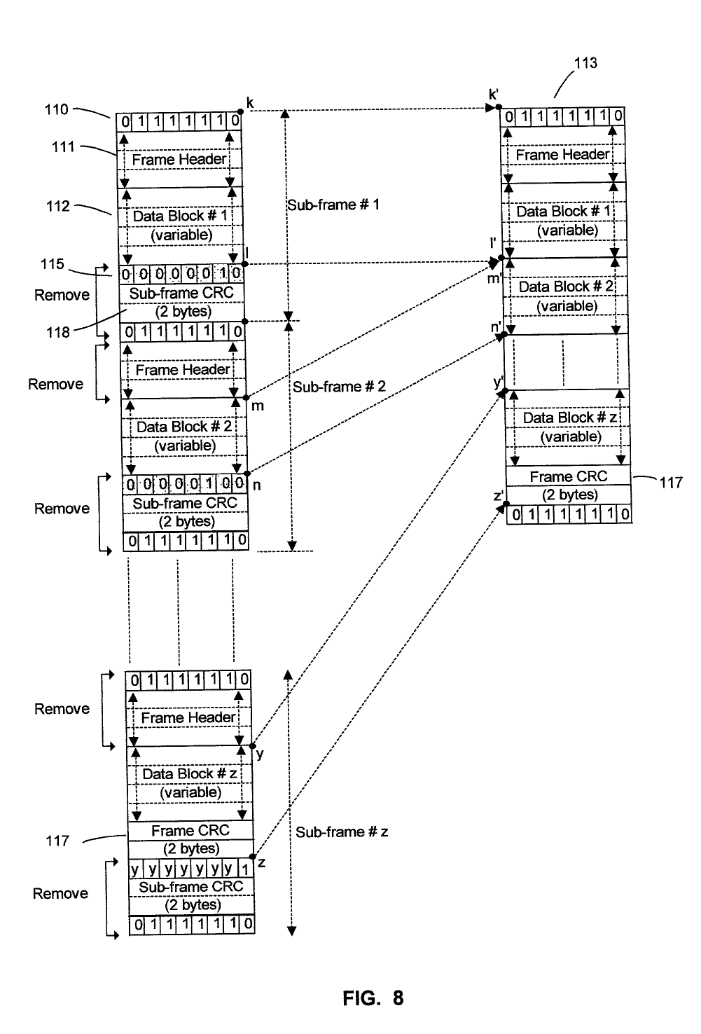

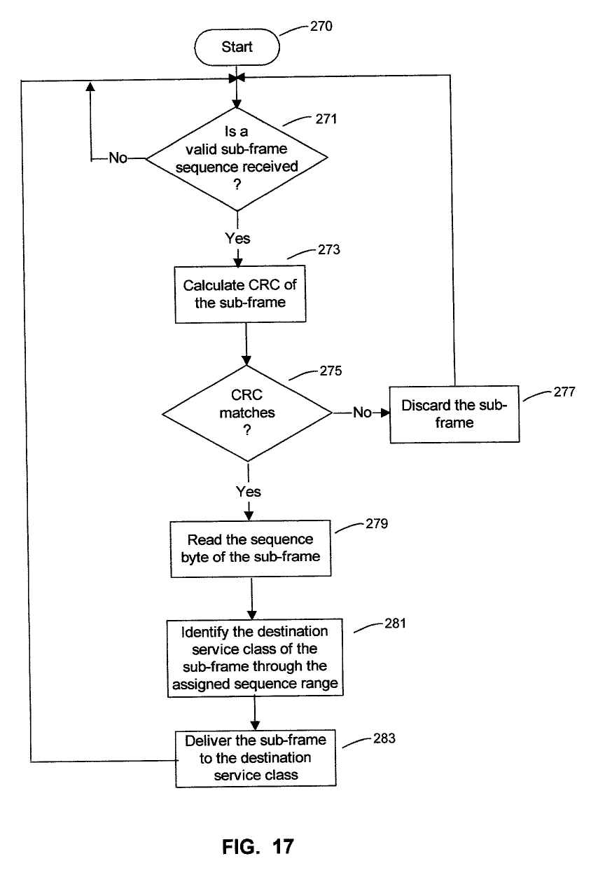

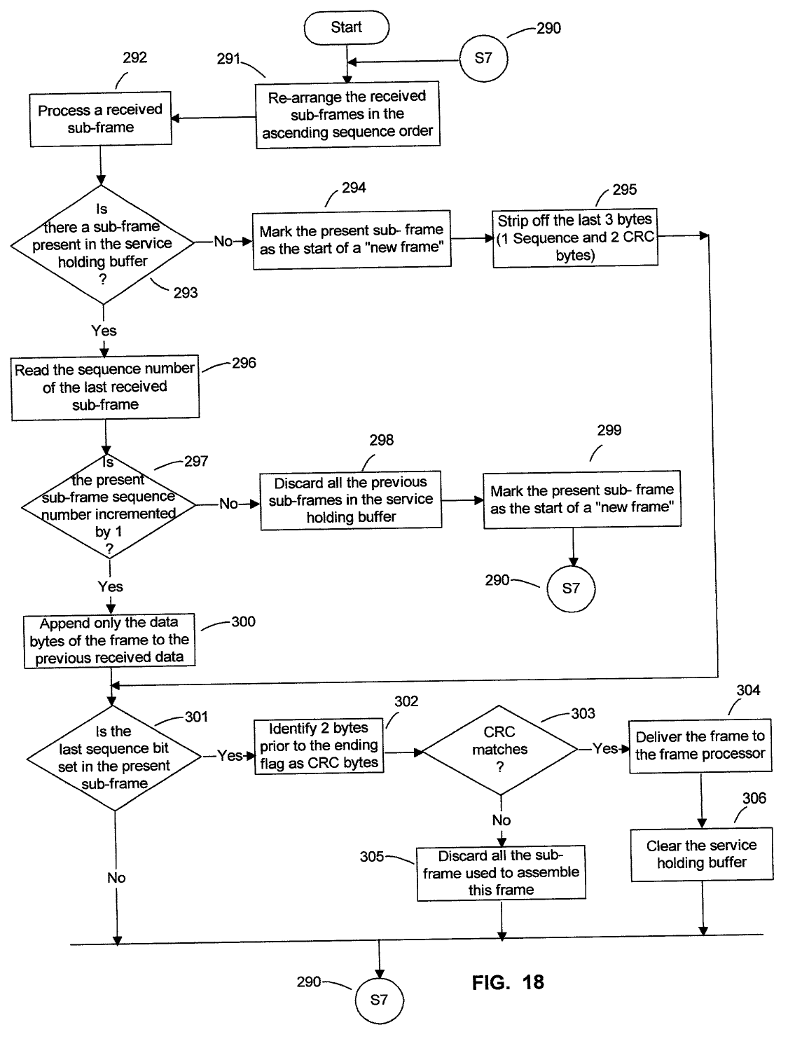

Referring now to FIG. 8, a block diagram illustrating the method and steps of the present invention for constructing the original frame at the receiving end by assembling the received multiple sub-frames belonging to a particular service class. The system processor at the receiving end identifies the sequence number of each of the received sub-frames by examining the 7-bit sequence part of the sub-framing byte. As illustrated, the received sub-frames are assembled in the ascending sequential order for a particular service class. The system process at the receiving end extracts the information contained in the first sub-frame #1 of the service class, i.e. the opening flag 110, the frame header 111, and the first data block #1, 112. As shown, it maps the portion k-i of the sub-frame #1 to k′-i′ portion of the frame 113. The trailing bytes of sub-frame #1, i.e. sequence byte 115, sub-frame's CRC 118, and the closing flags, are removed at the receiving end. The next sequential order sub-frame, i.e., sub-frame #2, only the data block #2 (m-n) is extracted and appended after the data block #1 (m′-n′). The receiving end continues to extract only the data portion of the all sub-frames that follow. The last sub-frame #z has the LS bit set to 1 in the sub-framing byte which indicates that the said sub-frame contains the last segment of the original frame. The receiving end maps the y-z data portion (the data block #z+Frame CRC bytes, 117) to the y′-z′ of the frame 113. The terminating flag is appended at the end to define the frame boundaries of frame 113. As it will be described later with reference to the receiving algorithm, FIG. 17, that the system algorithm performs the CRC check on the entire received frame 113 and the result is compared with the intact received original frame CRC. If there is a match then the frame is delivered to the frame processor, otherwise, the frame is discarded. It will be the responsibility of the higher communication layer (transport layer) at the sending end to retransmit the data lost in the discarded frame.

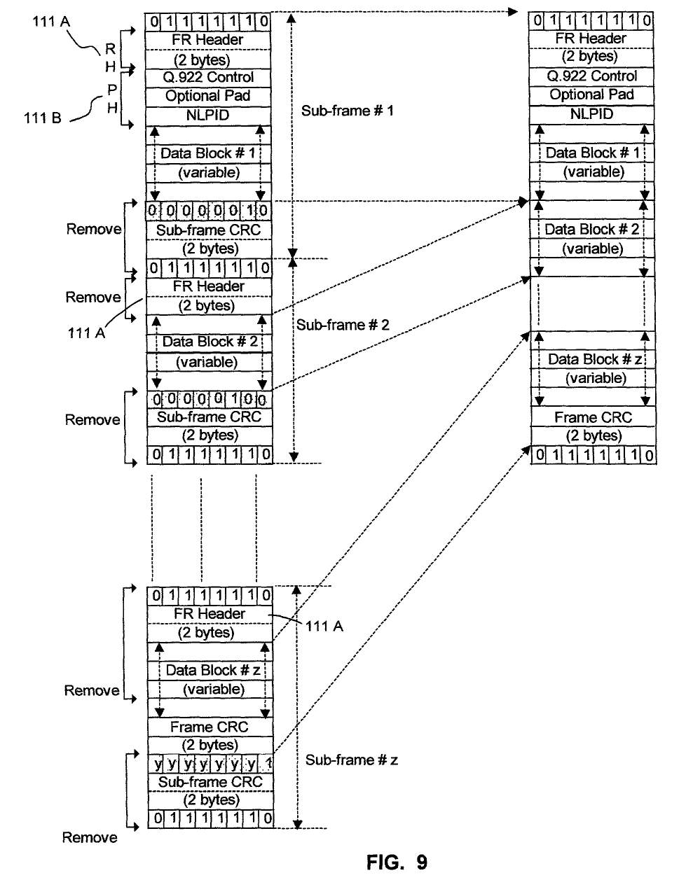

FIG. 9 demonstrates the reassembling procedure for a standard frame relay format. The received sub-frames carries several segments of an original frame relay format frame. At the receiving end the sub-frames are reassembled in accordance with the procedure described in reference of FIG. 8 to reproduce the original transmitted frame.

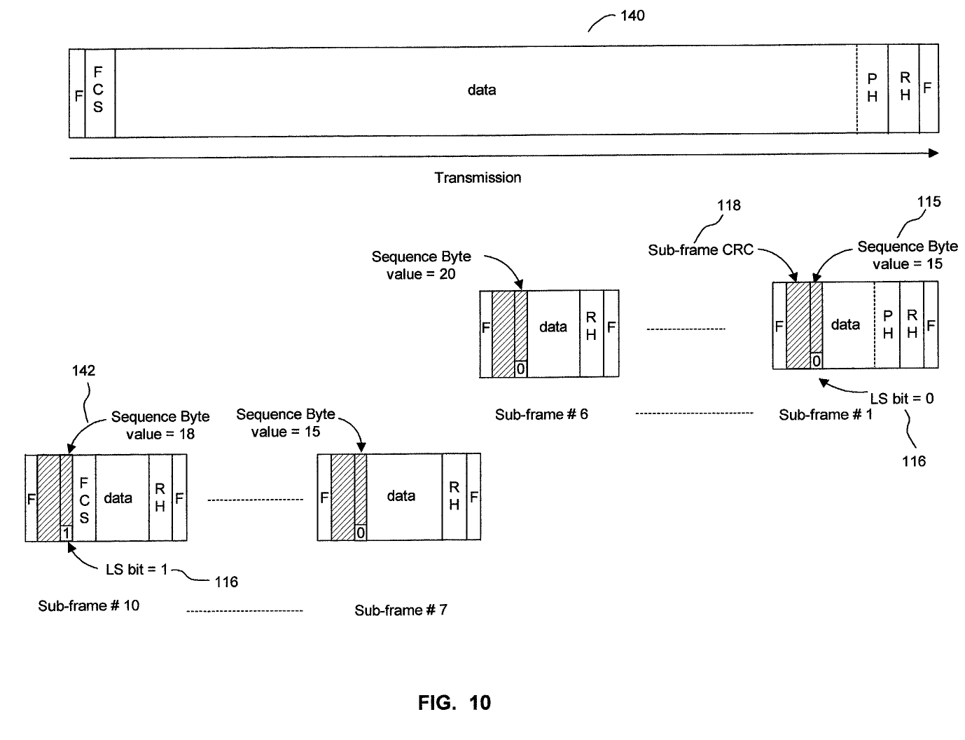

Turning now to FIG. 10 which illustrates a procedure to segment a relatively long size frame, e.g., token ring frame, into multiple frame with the repetition of sequence numbers assigned to a particular service class. This situation may arise when a small sequence number range is reserved for a particular service class which needs to segment a large frame into numerous sub-frames. For illustration purpose, a priority service class is assigned a sequence range of 15-20. A large frame 140 arrives in the service queue and needs to be transmitted through a multiple number of sub-frames. The first sub-frame #1 uses the sequence number of 15 in its sub-framing byte 115 and sets the LS bit 116 to 0 indicating more sub-frames to come. The system processor continues to transmit the sequenced sub-frames until it reaches the last reserved sequence number boundary of the service class, i.e., 20. At this point, the frame 140 is not entirely transmitted. The system processor sets the sequence number to 20 and the LS bit value to 0 in the sub-framing byte of the sub-frame #6 indicating that it is not the last sub-frame. The system processor sends the next segment of the frame 140 in sub-frame #7 with the sequence number rolled back to the designated initial sequence number, i.e., 15 in the sub-framing byte. The LS bit value is again set to 0 indicating the present sub-frame is not the last sub-frame. The last segment of the frame 140 is enclosed in the sub-frame #10 with LS bit set to 1 indicating the fact that the said sub-frame carries the last segment of the frame 140.

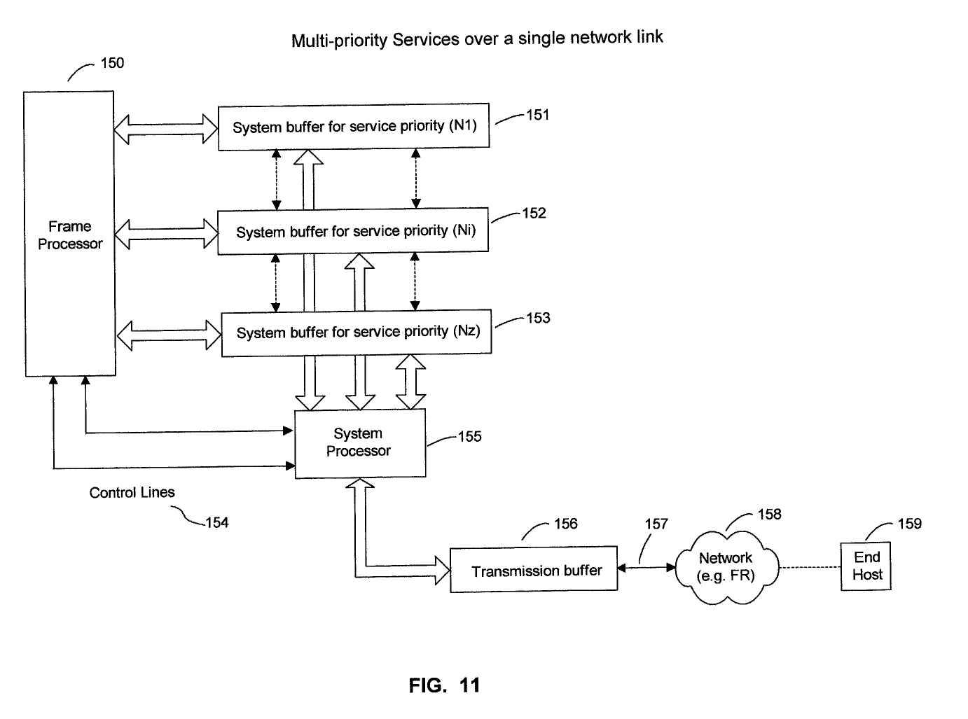

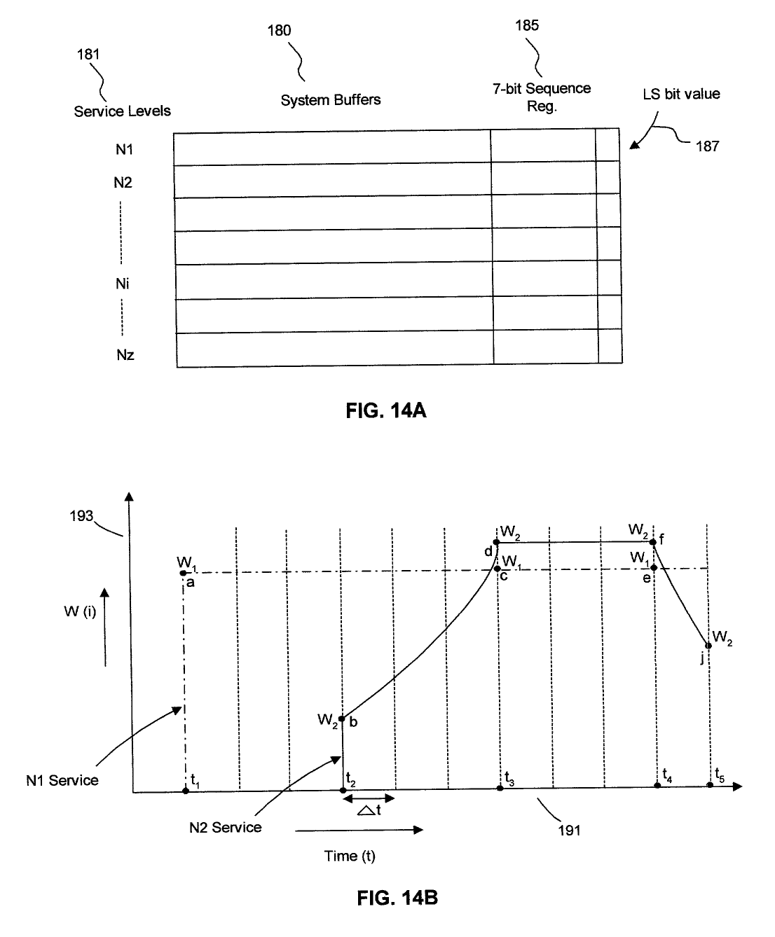

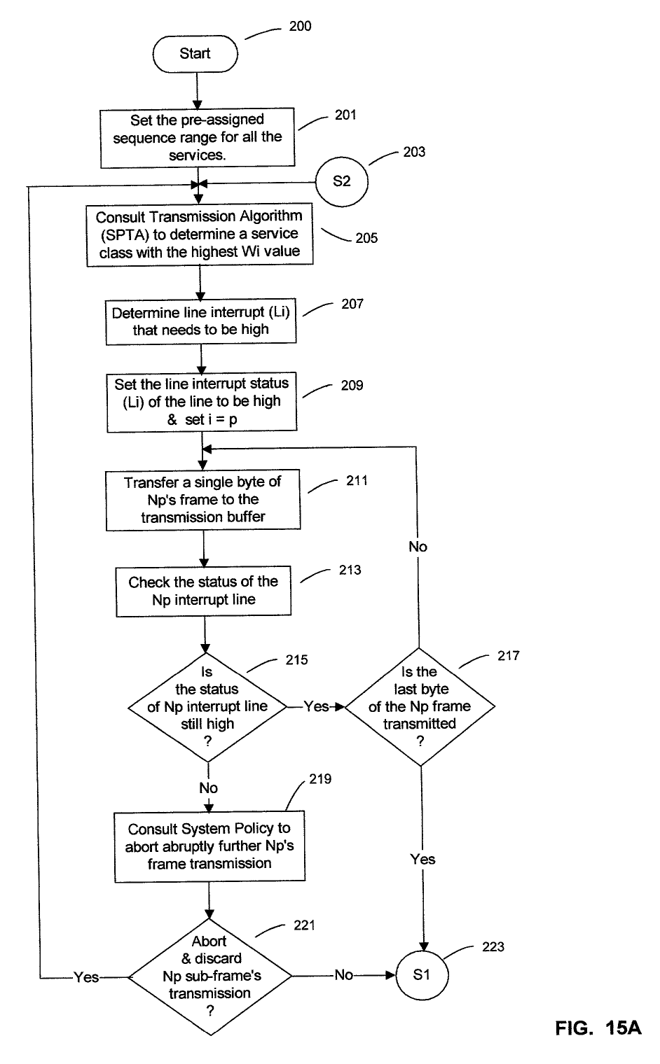

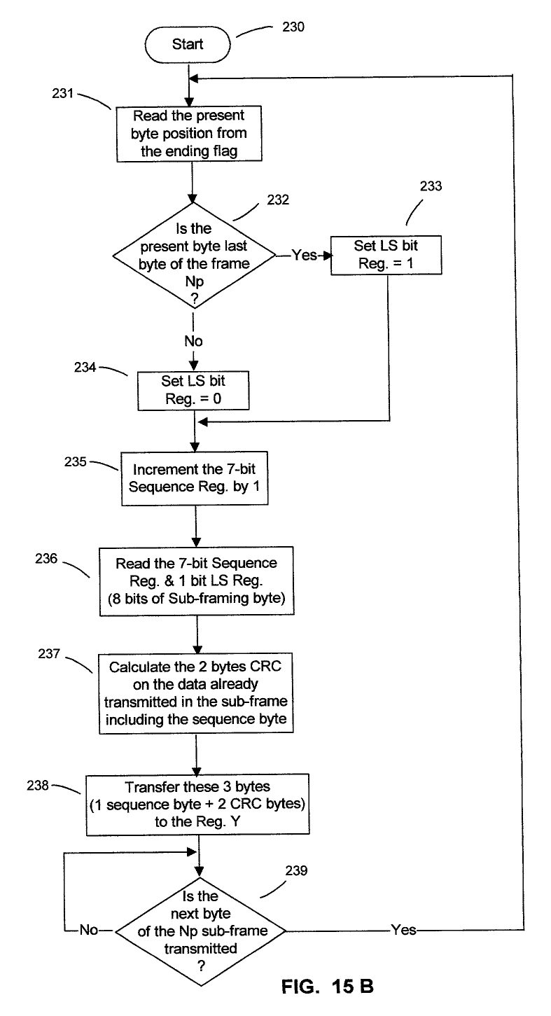

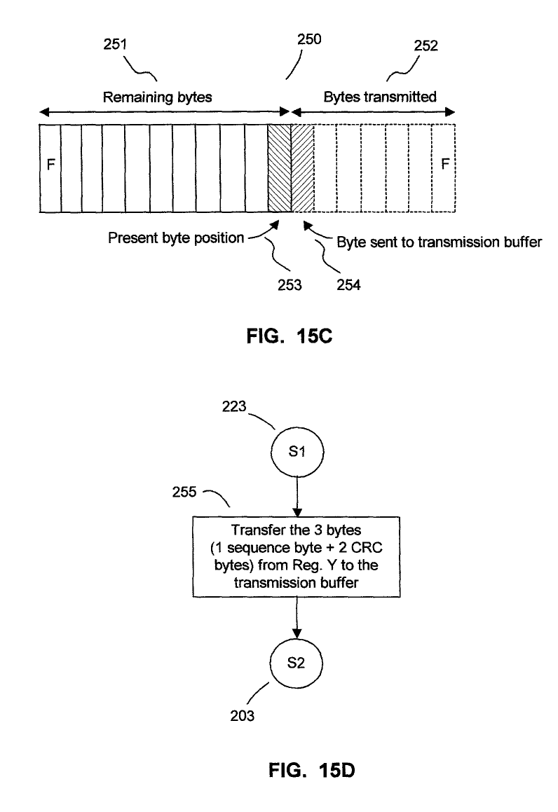

Referring now to FIG. 11, the diagram illustrates the high level system architecture capable of transmitting multi-priority services over a single communication link. Illustrated is the frame processor 150 which delivers the data-link frames in their native format to the respective priority service class buffers 151 to 153. For illustration purpose, the priority hierarchy is assigned in ascending order, i.e., N1 service being the highest priority and the Nz being the lowest service priority. The system process continuously polls the line interrupt status (Li) of each of the service priority classes. The high state of Li determines which service priority can transfer a single byte of data to the transmission buffer. The Li status of all the service priority classes is control by a System Transmission Policy Algorithm (STPA). The SPTA controls the Li status of all the service classes. The SPTA can update the line status, Li, if desired, of the service classes with a time resolution equivalent to the transmission time for a single byte on the communication link. In other words, after transmitting a single byte of a frame of any priority service class the STPA can dictate and decide which byte, either belonging to the same priority class or any other priority class needs to be transmitted next. By implementing this preferred technique the STPA can fully control and manage the transmission of any frame in any priority service class to a resolution equivalent to a single byte of data. The STPA can be used to update the line status, Li, of any service class with a time interval equivalent to the transmission time of one byte or multiple bytes. The frequent updates of line status, Li, of the service classes by SPTA can provide a better bandwidth resolution but may demand a high processing power. The scope and method for using the STPA are described with reference of FIGS. 14A-15D

Turning back to FIG. 11, the system processor 155 transfers an active frame data on a per byte basis to the transmission buffer 156. After transmitting every single byte of an active frame the system processor 155 polls to determines the high line interrupt (Li) status of the present service class being transmitted. If the line interrupt (Li) status of the present service class is not changed (still high) the system process 155 transfers the next byte of the frame to the transmission buffer. On the other hand, if the system processor determines that the line interrupt (Li) status of the present service class is changed it consults the system policy to determine how to end further transmission of the frame being transmitted from the present service class. For smooth termination of the sub-frame, appropriate trailing bytes as discussed in reference of FIG. 6B are added. The transmission buffer 156 injects the data bytes through a single link 157 to the Network 158. The Network 158 can be any type of data link network to carry the data link frame traffic. The end host 159 interfaced with the network 158 receives the transmitted frames. Since there is only one communication link between the transmission buffer 156 and end host 159 the sequence number of the transmitted sub-frames is always preserved.

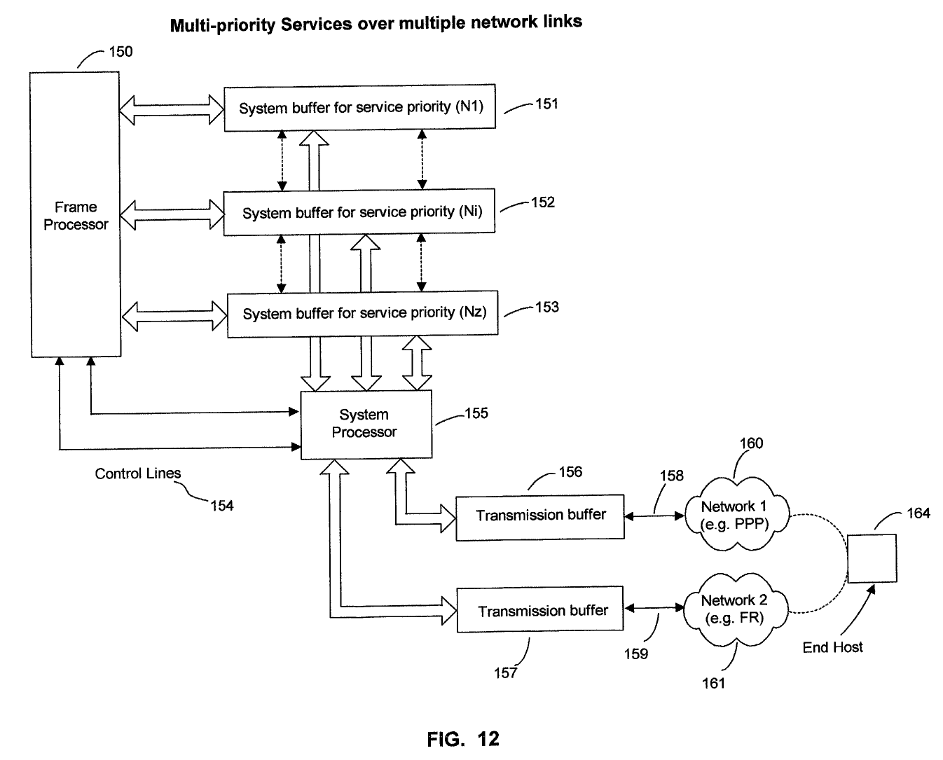

Turning now to FIG. 12 which illustrates implementation of the presented embodiment over multiple communication network links. In this network architecture the system process 155 has access to multiple paths that can simultaneously deliver data traffic to the end host 164. The system processor 155 can deliver the data either through the transmission buffer 156 or transmission buffer 157. The transmission buffer 156 uses the link 158 and via Network 160 delivers the traffic to the end host 164. On the other hand, the transmission buffer forwards the data traffic to the destination host 164 through link 159 and via Network 161.

Since there are two links available to the system processor 155 it can simultaneously utilize both links 158 and 159 to deliver the traffic to the destination host 164. Using multiple links simultaneously the system process 155 can enhance the net throughput of the transmitted data-link frames. To augment the available bandwidth for both links an outgoing frame can be segmented into multiple sub-frames and each sub-frame can be independently routed through all the available networks to reach to the destination host. The goal of this scheme is to divide an outgoing ‘big frame’ into two segments (in this case) and the resulting two sub-frames each carrying one of the two segments of the original frame are simultaneously transmitted to the destination host 164 through two different independent networks 160 and 161. The two data segments being carried in two sub-frames should be divided in such a proportion that the trailing bytes (sub-frame CRC and ending flag bytes) of each sub-frame travelling through different networks reach at the end host at the same time. To understand this technique conceptually refer to FIG. 13A which illustrates two sub-frames, 171 and 172, each carrying one of the two segments of said frame.

An object of the preferred embodiment is to present a technique that can be used to estimate the size of each transmitted sub-frame to meet this requirement. The total delay that a sub-frame consumes to reach from the transmission buffer to the end host is mainly the sum of two factors, serialization delay (Sd) and network delay (Nd). Serialization delay is the amount of time that the line interface takes to put a sub-frame data on the link. Whereas, the network delay represents the time that a sub-frame takes to travel through various switches and access paths to reach to the end host 164. In a typical real world network the access bandwidth of the transmission buffer 156 to link 158 can be quite different than the access bandwidth for the transmission buffer 157 to link 159. Similarly, the network delays experienced by transmitted data-link frames through Network 160 can be significantly different from the Network 161. In addition to different network delays, both networks are subjected to jitter which is unpredictable and varies with time and other network elements.

FIG. 13B visually demonstrates how frame 170 can be segmented into two sub-frames of different length in such a proportion that the resulting two sub-frames 171 and 172 traveling independently through Network 160 and 161 reach to the end host 164 at the same time. The system processor 155 divides a frame 170 consisting of D bytes into two sub-frames 171 and 172. Referring to FIG. 13B, the D1 bytes portion, w-x, of the original frame 170 is mapped into w′-x′ part of the sub-frame #1, 171. Whereas the remaining data D2 bytes, y-z portioned is carried into the y′-z′ part of the sub-frame #2, 172. As previously explained with reference of FIG. 6B, the appropriate values of the trailing bytes (sub-framing and the sub-frame CRC bytes) are appended to the respective sub-frames. The system processor 155 delivers the first sub-frame 171 via the first link 158 and the second sub-frame 172 through the second link 159. These two said sub-frames 171 and 172 are simultaneously transmitted by the system processor 155 and reach the end host 164 at the same time. It is worth it to observe that the access bandwidth of the links connected to the end host 164 can also be different. The connected links to the end host 164 links may also offer different serialization delays to the incoming data link frames. These delays are considered as the part of network delay components.

For illustration purposes the following described scheme covers two networks as depicted in FIG. 12. The scope and implementation of this scheme can be easily extended to cover multiple network scenarios. Referring back to FIG. 13A, in order to determine the appropriate size of the two sub-frames 171 and 172, each containing a single partition of frame 170, the first task is to find out the transient time difference through the two available networks 160 and 161. To determine this time difference the system processor 155, at initialization time, segments an outgoing frame to end host 164 into two sub-frames of equal size. The two resulting sub-frames of the same size are simultaneously transmitted to the end host 164. Due to different delay characteristics of each transient path, as discussed earlier, the two sub-frames arrive at the end host 164 at a different time. Assuming that the transient delay through the network 160 (T1) is less than the said delay through network 161 (T2), the end host 164 determines this time difference (ΔT) between the two sub-frames, (171 and 172) arrival time as follows.

ΔT=T2−T1

This ΔT signifies how quickly the sub-frame 171 arrived at the end host 164 as compared to sub-frame 172. The system processor at the end host 164 can start the reassembling process only when the trailing bytes, ending flag and the CRC bytes, of both sub-frames 171 and 172 are received in the designated service class buffers at the ending host 164. This implies that the amount of time ΔT for which the sub-frame 171 has arrived earlier than 172 it could have carried additional ΔD bytes of data in its payload so the trailer bytes of both said sub-frames could have arrived at the end host 164 almost at the same time for reassembling and CRC checking. The information about the delay difference, ΔT, is used by the system processor 155 of the sending host to determine the additional amount of payload, ΔD, the sub-frame 171 should have carried. Once the end host 164 determines the difference ΔT, this information is conveyed to the system processor 155 by the ending host 164 through small proprietary data frames. The next task is to determine how many more data bytes could have been added in the sub-frame 171. The answer comes from the value of the access bandwidth B1 configured for the link 158. The number of ‘extra’ data bytes (ΔD) that the link 158 with available bandwidth B1 can deliver in ΔT can be given as:

$$Δ D = \frac{Δ T \times B1}{8}$$

The resultant ΔD bytes can be distributed evenly between the two said sub-frames payloads.

D1 = D/2 + ΔD/2 → (1)
D2 = D/2 − ΔD/2 → (2)
D2 = D − D1 → (3)

This implies that the payload of sub-frame 171 can be increased by ΔD/2 and, also, proportionally the size of the sub-frame 172 can be reduced by ΔD/2 bytes.

It should be noticed that the above relation provides a very rough estimate for adjusting the segment size of each said sub-frame at the initialization time. In deriving the above conclusion it is assumed that the delay experienced by a frame and the frame size has a linear relationship. This may not be an accurate and valid assumption. The network components may produce different levels of delay for different frame sizes The network elements can produce variable delay values and, as a result, the desired timing synchronization for the said sub-frames (171 and 172) to be received by the end host 164 at the same time can also be drifted. A more accurate estimate about the proper size of the said sub-frames can be achieved by implementing a recursive prediction error estimator. Historically, recursive algorithms have been widely used to estimate the very essential delay parameters, round trip time(rtt) and retransmission time out (rto) for the TCP layer protocol. The source TCP uses this information to determine the proper window size for the transmitted TCP segment to the host. The end host 164 utilizes this algorithm to ensure that the ΔT values are always kept within a certain defined window range as the network delay changes. If the recursive algorithm at the host reports that the ΔT is falling out of a pre-defined range then the new updates about the ΔT values are conveyed to the system processor 155. The system processor 155 also relies upon a recursive algorithm to calculate the optimum sub-frame size. The new received values of ΔT will be incorporated in the system processor 155 to calculate more adequate said sub-frame sizes. The above presented scheme ensures the maximum and simultaneous utilization of the available link access bandwidth and network resources. The following is the strategy commonly used in implementing recursive algorithms. Given an initial measurement “a” the next measurement can be estimated as

The factor “m” is a new measurement, (m−a) represents an error in the prediction and “g”

a←a+g(m−a)

(0<g<1) stands for gain. According to the above expression the average measurement “a” is based on the old measurement plus some fraction of the prediction error. The prediction error is the sum of two components; error in the measurement due to “noise” (random, unpredictable fluctuation) and error due to bad choice of “a”. Calling the random error Eᵣ and the estimation error Eₑ the above impression can be re-written as;

a←a+gEᵣ+gEₑ

The gEₑ terms gives “a” a kick in the right direction and the “gEᵣ” terms gives a kick in a random direction. Over a number of samples, the random kicks cancel each other out and the algorithms tends to converge to the correct average.

As mentioned earlier, the ending host 164 expects to receive the data link sub-frames 171 and 172 within a certain delay window (ΔT). The ending host 164 constantly keeps track and updates the ΔT value using the recursive algorithm. If this average delay difference, ΔT average, changes beyond a defined threshold level then the ending host convey the ΔT average to the system process 155. The system process 155 which keeps track of the optimum D1 and D2 values based on recursive algorithm incorporates the updated feedback on the ΔT average from end host 164 in its algorithm to recalculate the best suited values of D1 and D2. The new calculated optimum values of D1 and D2 will tend to decrease the ΔT values. These new ΔT values, once injected into the recursive algorithm of the end host 164, will tend to converge the average ΔT value within a defined window range. It should be observed that the use of recursive algorithm ensures that the average ΔT measurement reflects the steady state condition of the network components. Any sudden jitter or momentary changes in the network components will be absorbed in the recursive algorithm and will not cause a sudden drift in the average ΔT measurement.

The following discussion describes a condition where it becomes more efficient and advantageous to send the entire frame without any segmentation through a single network path. This particular condition can be derived from equation 2. The condition for no segmentation of the frame implies D2<0. Substituting this value in equation 2 yields

$$\frac{D}{2} ⩽ \frac{Δ D}{2}$$

$$Δ D ⩾ D ⟶ ( 3 )$$

The interpretation of this equation relates to the fact that if the calculated value of ΔD is larger than the original frame size D, it will be quicker to send the entire frame through the link with shorter transient delays than segmenting the frame and sending the resulting multiple sub-frames through diverse links to the destination.

It should be noted that the system processor 155 continuously monitors the line interrupt (Li) status of all priority service classes after delivering every single byte of the sub-frames 171 and 172 to the respective transmission buffer 156 and 157. In the event a higher priority frame becomes ready for transmission the system processor 155 interrupts the transmission of the lower priority frame. Using equation 3 the system processor 155 first determines if it is necessary to segment a higher priority frame into sub-frames. If the segmentation is not necessary, the system processor 155 delivers the entire high-priority frame without any segmentation to the Network with lower delay e.g. Network 160. On the other hand, if equation 3 justifies the segmentation of a high priority frame then the system processor 155 segments the high priority frame into two sub-frames of optimum length. These two higher priority sub-frames interrupt the ongoing transmission of the lower priority sub-frames (e.g. sub-frame 171 and sub-frame 172) being transmitted through the links 158 and 159 respectively. Once the high priority sub-frames are inserted during the course of transmission of the low-priority sub-frames they causes an additional delay for the low priority sub-frame when they resume transmission. Also, the injection of high priority sub-frames into the low-priority sub-frames will disturb the optimum number of bytes as calculated previously by the system process 155 for transmission through each individual link (158 and 159). To compensate for this disturbance the system process 155 segments the next outgoing frames in such a proportion that the resulting sub-frame size ratio of D1 and D2 as determined by the recursive algorithm before the interruption remains unchanged. This ensures that the trailing bytes of the sub-frames belonging to future transmitted frames arrive at the end host almost at the same time.

Turning now to FIG. 14A which represents internal system buffers architecture for storing and processing the incoming data link frames. The frames that needs to be transmitted are placed in the respective system buffers 180 according to their assigned service class. The 7-bit sequence Register 185 is initialized to contain the very first sequence number of the designated sequence range assigned to a particular service class. As a sub-frame of a service class is transmitted this number is sequentially incremented. The sequence number rolls back to the initial value once it reachs to the last defined sequence number of a service class. The LS bit value 187 determines if a sub-frame being transmitted contains the last segment of the frame or not. When a sub-frame of a service class containing the last segment of a frame is transmitted the LS bit 187 is set to 1. The value of the 7-bit Register 185 and the LS bit value 187 are carried in the sub-framing byte of the sub-frame.

The following discussion relates to the architecture and implementation of the System Transmission Policy Algorithm (STPA) that is used to determine the transmission priority of a given service class. A user can define and customize several different parameters in SPTA and each parameter can have a priority level associated with it. Each service class can be individually identified by a certain set of parameters and different service classes can contain completely different parameters which in turn can be a mixture of fixed or variable (e.g. time dependent) parameters. The STPA calculates a number called Weight Number, Wi, for each of the service classes by executing the functions defined in the parameters of that particular service class. The resulting Wi numbers of all the individual service classes are compared to find a service class with the highest Wi Number. The SPTA sets the line interrupt (Li) status of a service class that yields the highest Wi number. Until the next time this calculation is performed this particular service class has the permission to transmit any number of frame bytes received in that particular service class. As previously discussed the present invention can manage the link bandwidth with a resolution equivalent to a single byte. To meet this refined resolution the SPTA has to execute the individual functions of all the service classes in an interval equivalent to the serialization delay of a single byte on the link. At a low link speed this can be handled by the software routines, but in a high speed link environment the SPTA can be implemented in ASIC (Application Specific Integrated Circuits) for faster execution. A number of parameters can be included to define a function of a service class. Each parameter can be associated with a given weight. A function relationship can be expressed as follows;

$$\begin{matrix}f ( x ( i ) , … & x ( j ) , & u ( t ) , & N ( bytes ) ) & {\vert}_{N = 1} = & {W}_{1} \\ & & ⋮ & & & ⋮ \\ f ( x ( i ) , … & x ( j ) , & u ( t ) , & N ( bytes ) ) & {\vert}_{N = i} = & {W}_{i}\end{matrix}$$

In the above relation “f” defines a user function that is executed on user defined parameters. Some parameters can be fixed whereas the other can be variable. Also, these parameters can be time dependent, i.e. their values can be changed with time (e.g., u(t)). In addition, a parameter's value can depend on the number of bytes transmitted (e.g. N(bytes)). It could be noticed that a function defined for a service class can be formulated using simple or complex combinations of different parameters. Depending on a specific service class requirement any function can be crafted. It is up to the available and acquired functionality of software or hardware to execute these functions within a desired time limit for all the service classes involved.

Turning now to FIG. 14B which illustrates an example of two service classes, N1 and N2, defined with different user parameters. The user function which is being executed after every At interval generates the corresponding W(i) numbers for both service classes. For the purpose of illustration, N1 service class represents a mission critical application and the frames belonging to this service seek immediate transmission. On the other hand, frames belonging to N2 service class must remain in the system processor for a certain period of time before they are eligible for transmission. The further requirement imposed on the N2 service class is that if a frame in the said service class does not get transmitted after a pre-defined period of retention, the transmission requirement of a frame in the said service class increases exponentially with time. As shown in FIG. 14B the SPTA executes the function defined by the user parameter for the service classes N1 and N2 at time t1 and finds a value of W1 for service class N1 and a zero value of W2 for the service class N2. (N2 service class is not qualified for transmission till the time t2). Since the W1 value is higher than W2, which is zero at t1, it sets the Li status high for the N1 service class. Any frame that is received in this service class is allowed to its transmission on the link. The vertical dashed lines represent the regular time interval when the SPTA executes the functions defined for the service classes N1 and N2. At the time t2, the SPTA determines that the function value at point “b” for the service class N2 results in a weight of W2. Still W1 is higher than W2, any frame in the N2 class will be given priority. If there is no frame ready for transmission at the t2 time in the service class N1, then any frame ready for transmission in the service class N2 is allowed to be transmitted. Consider a situation where there is enough data available in the service class N1 buffer for transmission that the service class N2 never gets an opportunity to transmit its data. In the user defined parameters for the function of service class 2 a time dependent parameters is included which increase exponentially or by any other proportion with time. At time t3 when the SPTA calculates the respective transmission priority weight for both classes it finds that the resulting W2 value has exceeded W1 value. At the point c it sets the line interrupt status, Li, for the service class N2 allowing it to transmit the data and regardless of the fact that service class N2 has some data to transmit. Another user byte dependent parameter defined in the function restricts the maximum number of bytes transmitted by the service class N2 as a higher priority. As a result of this byte dependent parameter, the W2 value calculated by the SPTA after the time t4 starts to drop. At the time t4, the W1 value again exceeds W2 and as a result the service class N1 is again declared as a higher priority service class. As it can be realized from this discussion that any kind of user specific parameters, fixed or variables, can be included in defining the function of a priority service class. This entire scheme provides a very powerful methodology to manage and control the link bandwidth in any manner or proportion desired.

Referring to FIG. 15A, a flow chart illustrates the top level operation of the transmitting device constructed in accordance with the preferred embodiment of the present invention. At step 201, the system algorithm initializes the 7-bit sequence registers of all the service classes being used to their respective initial sequence number assigned to their respective service range. The pre-assigned sequence range for each service class is mutually agreed upon between the sending device and the receiving device before any data transmission as discussed earlier. The sequence register associated with each service class contains the start and the end sequence range of a service class. In step 205, the system processor consult the System Priority Transmission Algorithm (SPTA) to find out a service class with the highest priority weight, Wi, among all the active service classes. At step 207 the system process determines the line interrupt (Li) of a service class that needs to be set high.

The system processor sets the Li status high in step 209 and sets i=p implying that the present service class is an active service class being transmitted. A single byte of a frame in the present service class is transferred to the transmission buffer in step 213. Step 213 checks the line interrupt (Li) status of the present service class. The decision box 215 determines if the Li of the present service is still high. If so, it goes to decision box 217 to determine if the last byte of the frame in the present service class has been transmitted. Returning back to the decision box 215 if the Li status of the present service class is changed to low, the system algorithm consults the guideline for further transmission of the present frame in step 219. The decision box 221 determines if further transmission of the present frame should be abruptly aborted or not. In certain situations it may be preferred to discontinue any further transmission of the frame. For instance, if the only bytes transmitted so far in the Np frame are the few bytes belonging to routing header of the frame, and there are no data bytes transmitted so far then it may be more practical to discontinue any further transmission of the Np frame. On the other hand, if a significant number of data bytes of Np frame have been transmitted then it would be preferred to terminate the sub-frame with proper values of the sub-framing byte and the sub-frame CRC bytes. Returning back to decision box 217, which determines if all the data bytes of Np frame are transmitted. If so, the control passes to State 1 (S1), 223. The continuation of the algorithm from State 1 (S1) is given in FIG. 15D. If step 217 determines that there are remaining bytes of the frame left for transmission then the control goes back to step 211 to repeat the loop to transmit the next single byte of the frame in the present class of service.

Referring back to step 221, the implemented policy procedure in step 221 may require any further transmission of the frame to be aborted. If so, the further transmission of the frame is abruptly aborted and the control is returned to step 205 to process the next service class that has been prioritized by the SPTA. One method to abruptly discontinue the transmission of the present Np frame is to start transmitting the next high priority frame without sending any proper trailing bytes. Since the present frame is not properly terminated by the correct CRC value, the partial frame will be discarded by the next data-link device which attempts to verify the CRC value of the sub-frame. If the decision box 221 determines that it is necessary to end the further transmission by appending the proper sub-framing byte and the sub-frame CRC bytes then the control goes to state S1, 223 which is further described in FIG. 15D.

Now referring to FIG. 15B of the preferred embodiment is the CRC sub-routine which dynamically calculates the proper CRC of a sub-frame that may need to terminate. As discussed earlier, the transmission of a data frame can be interrupted after transmission of any number of bytes. For proper termination of a sub-frame at any byte boundary the correct CRC value needs to follow after the sub-framing byte of the sub-frame. This condition requires that the system algorithm should always have an updated CRC value ready at any time when the sub-frame needs to be terminated. This updated CRC value should be properly calculated over the previous transmitted bytes and the sub-framing byte of the sub-frame. FIG. 15C illustrates this concept through a frame 250 which is being transmitted. Segment 251 indicates the remaining bytes of the frame 250 yet to be transmitted. Segment 252 represents the bytes which are already transmitted. Byte indicated by the number 254 has already been transmitted to the transmission buffer by the system processor. This corresponds to step 211 in FIG. 15A where the system processor is transmitting byte 253.

The CRC sub-routine presented in FIG. 15B runs parallel with the system algorithm. It always ensures that the correct and updated CRC value of a sub-frame is available to the system algorithm in the event it needs to terminate a sub-frame properly. The sub-routine calculates the current CRC value of the sub-frame covering all the previous transmitted bytes of frame 250 including the present byte 253 and the updated sub-framing byte value of the corresponding frame. The said algorithm described in FIG. 15B reads the position of the present byte of a frame with respect to its ending flag as shown in step 231. In the decision step 232, it determines whether the present byte is the last byte of the frame (including the CRC bytes of the original frame). If so, it sets the single bit Reg. LS value to 1 in step 233. If the present byte being transmitted is not the last data byte of the frame it goes to step 234 and sets the LS register value to 0. In step 235 it increments the 7-bit sequence register by 1 associated with the present service class. The algorithm reads the 7-bit sequence register and 1-bit LS Register values in step 236 to form the required framing-byte of the sub-frame. In step 237, the algorithm calculates the CRC value spanning over all the data bytes including byte 253 and the current updated value of the sub-framing byte. The algorithm transfers these three resulting bytes (1 sub-framing byte and 2 CRC bytes) of this operation to a Register Y. In the event the system processor needs to terminate the frame after transmitting the present byte 253, the Register Y already has the proper and required 3 bytes needed to be appended after the last transmitted byte (in this case 253, FIG. 15C). In step 239 the algorithm waits for the next byte transfer to the transmission buffer by the system processor. Once the next byte is transferred the control goes back to the start 230. The sub-routine recalculates the new CRC including updated values of data bytes transferred and the sub-framing byte.

FIG. 15D shows the continuation of the system algorithm as presented in FIG. 15A. The path S1, 223 to S2, 203 is followed by the transfer of the trailing three bytes from Register Y to the transmission buffer for proper termination of the present passing frame.

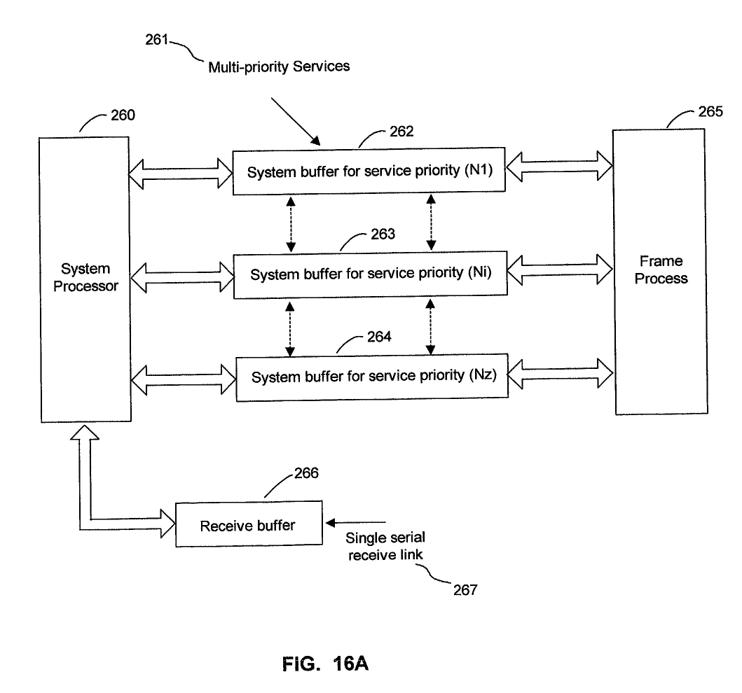

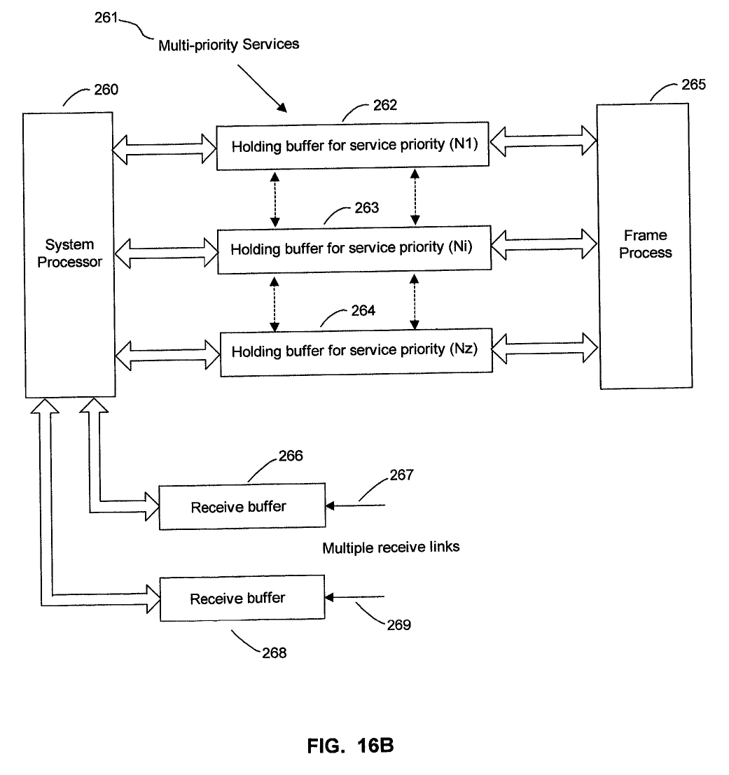

Turning now to FIG. 16A, a block diagram consisting of a single serial link 267 for receiving and processing the incoming data-link frames from its peer sending device is illustrated. Since the sub-frames are being received through a single link the sequence order of the sub-frames will always be preserved. The received sub-frames are forwarded to the system processor 260 which identifies the service priority class of the received sub-frames by reading the sequence range included in the sub-framing byte. Once properly identified, the sub-frames are transferred to the respective service system buffer for further processing. Finally, the frames are delivered to the frame processor 265 in the standard data-link frame format.

FIG. 16B represents a block diagram for the receiving process when there are multiple receiving links available. As discussed earlier in conjunction with FIG. 13B, the sub-frames can arrive out of sequence at the receiving end because of the dissimilar delay characteristics of the networks they traveled through. Once identified for the destination service class, the system processor 260 rearranges the sequence number of the sub-frames in the ascending order. After assembling the proper number of sub-frames the system processor 265 re-constructs the original frame and delivers it to the frame processor in its native data link format.

FIG. 17 illustrates the top level operation of a receiving device constructed in accordance with the present invention. Illustrated as initial step 271, it awaits for a sub-frame arrival. Upon receiving a sub-frame it calculates the CRC in step 273. The calculated CRC is matched in step 275 against the appended 2-bytes sub-frame CRC value prior to the ending flag of a sub-frame. If the match is successful then the sub-frame is passed to step 279 for further processing. Otherwise, step 277 discards the sub-frame and the control is returned to start 270 to await for the next incoming sub-frame.

It should be observed that discarding a multimedia frame because of its inaccurate contents may not be a preferential way. If a few bits in the payload of a multimedia frame are altered during transmission it is still worth it to deliver the frame. On the other hand, the CRC check of a multimedia frame is also not successful if the critical information bits contained in the sub-framing byte or the frame header are changed during the transmission process. If the bits in the sub-framing byte or the frame header are changed then the information in the frame can be misleading even in a multimedia frame. One possible way to get around this problem is to exclusively verify the critical information bytes of a multimedia frame. This can be accomplished by reserving the CRC check only for these critical bytes and excluding the contents of a multimedia frame.

Returning to step 279, after having a successful CRC match, the 7-bit sequence number of the sub-framing byte is read. Step 281 identifies the service class through the sequence number. Recall that a pre-assigned sequence number range is mutually agreed upon by the sending and the receiving devices at the time of initial configuration. Step 281 uses this sequence number information & delivers the frame to its destination service in step 283. After executing the step 283, the control is returned to start 270 for the processing of the next incoming sub-frame.

FIG. 18 shows the top-level operation of the service algorithm that operates on the sub-frames received by the individual service class. Illustrated as an initial step 291 the service algorithm rearranges the sub-frames received through multiple interfaces in the ascending sequence numbers. Step 291 is not necessary if there is only one communication link between the sending and receiving devices. In this case the sub-frames are always received in the same order as they are transmitted. The step 291 is only significant in the case of multiple communication links that may exist between the sending and receiving devices. The process in step 291 may include a state condition that waits for a pre-defined amount of time or hold a certain number of sub-frames in the event if it receives an out of sequence sub-frame. It should be observed that the step 291 only verifies that the received sub-frames always maintain an ascending sequence order. It does not take any action if single or multiple sequence numbers of the sub-frames are missing. Step 292 awaits for an ascending order sub-frame and processes it. Step 293 determines if there is any sub-frame already present in the service holding buffer. If so, it indicates that the received sub-frame is the part of a frame and contains a segment of the said frame. Otherwise, the present sub-frame is either the first segment of a new frame or by itself is a complete frame. In both cases the algorithm marks the received sub-frame as the start of a new frame (step 294). Step 295 strips off the last three bytes which constitutes 2-bytes CRC and the framing byte of the sub-frame as described in conjunction with FIG. 8. It retains the sub-framing byte information for further processing.

The algorithm proceeds from step 295 to decision box 301 where it determines the status of the LS bit in the sub-framing byte. If the LS bit is set it indicates that the present sub-frame is indeed a complete frame. In this case the step 302 identifies the last two ending bytes as the CRC bytes of the original frame. If the decision in the box 301 resolves to NO, this indicates that the received sub-frame is the first segment of a frame and more sub-frames will follow to make a complete frame. In this case the control goes back to start (S7, 290) to process the next incoming sub-frame. Returning to the decision box 303 the CRC is calculated on the entire frame and then this checksum value is compared with the last two ending bytes of the frame identified as the CRC bytes. If the CRC matches then the frame is delivered to the frame processor as indicated in step 304. Step 306 clears the holding buffer to ensure that any remaining data cannot corrupt the new incoming sub-frames. On the other hand, if the decision box 303 determines that the calculated CRC value does match with the appended 2-bytes CRC value the sub-frame will be discarded. Since the present sub-frame is discarded all the data in the previous sub-frames can no longer be useful. As a result step 305 discards all the previous data stored in the holding buffer. The algorithm goes back to state S7 290 to process the next sub-frame.

Returning to step 293, if there is already a sub-frame in the holding buffer then the algorithm proceeds to step 296. In this step 296 the algorithm reads the 7-bit sequence number of the previous received sub-frame in the service holding buffer. If there is no sub-frame loss then it is expected that the present sub-frame sequence number is the next logical sequence number then the previous stored sub-frame . The decision box 297 determines this condition. If the present sub-frame sequence number is incremented from the previous sub-frame then the algorithm proceeds to step 300 where it strips off all the header information and the last three bytes (2-bytes CRC and 1 sub-framing byte). It stores the sub-framing byte information to be used for the sequence comparison with the next sub-frame. Only the data portion is appended with the previous sub-frame data as shown in conjunction with FIG. 8. In step 301 the status of the LS bit is determined. If the present sub-frame has LS bit set to 1 it indicates that the present sub-frame contains the last segment of a frame and it has completed all the segments of the received frame. If so, the algorithm moves to step 302 and then to step 303.

As discussed earlier, during the operation of these steps the integrity of the entire data, as assembled from the individual received sub-frames is verified. If successful then the frame is passed to the frame processor, otherwise, it is discarded. Returning back to step 297 if the decision box 297 determines that the present sub-frame does not contain the desired next logical sequence number then it proceeds to step 298. The missing sequence number is a clear indication that a data segment is lost. Regardless of the fact that there is only one missing sub-frame or multiple sub-frames, all the assembled data from the previous sub-frames becomes useless. As a result, the algorithm discards all the previous data in the service holding buffer in step 298. It is possible that one of the missing sub-frames might contain the last segment of the frame. The service algorithm cannot determine if the missing sub-frame(s) contained the intermediate segment(s) or the last segment of the frame. It proceeds with a simple assumption that the last missing sub-frame contained the last segment of the frame. With this assumption it marks the present sub-frame as the start of a new frame in step 299. The logical reason behind this assumption is that if the present sub-frame is not the start of a new frame then the frame's original CRC value contained in the last received sub-frame cannot be matched. As a result this “incomplete frame” will be discarded at step 303 of the algorithm. On the other hand if this assumption is true and the present sub-frame is indeed the start of a new frame then the original CRC value of the frame as carried in the last sub-frame will be matched in step 303. After executing step 299 the algorithm goes back to state S7 290 to process the next sub-frame.

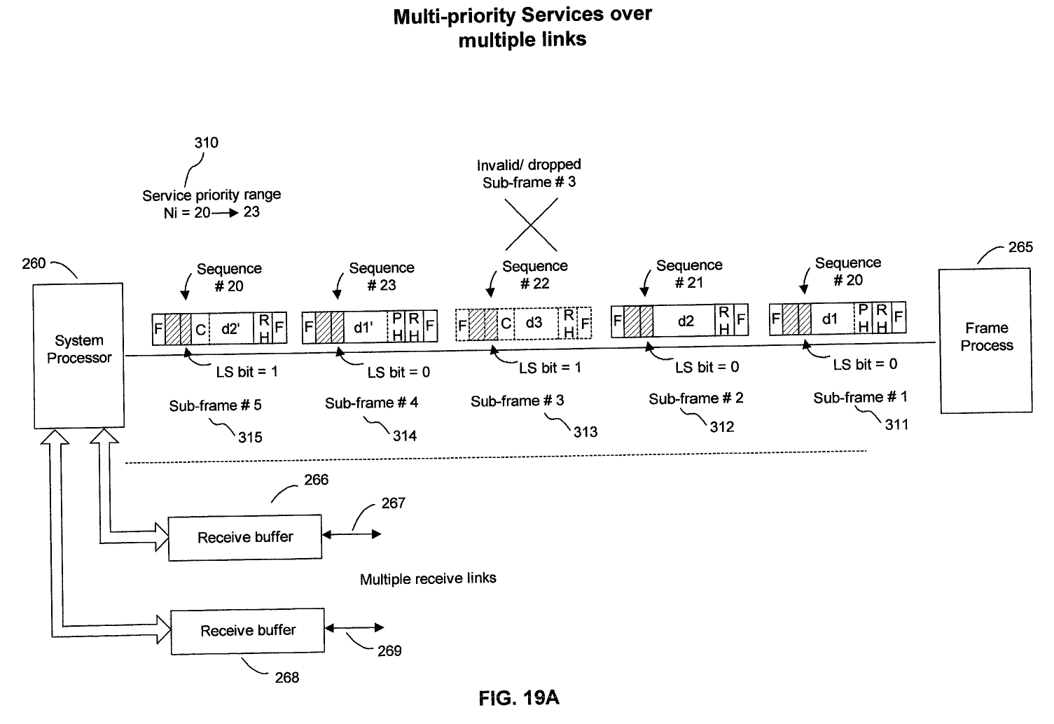

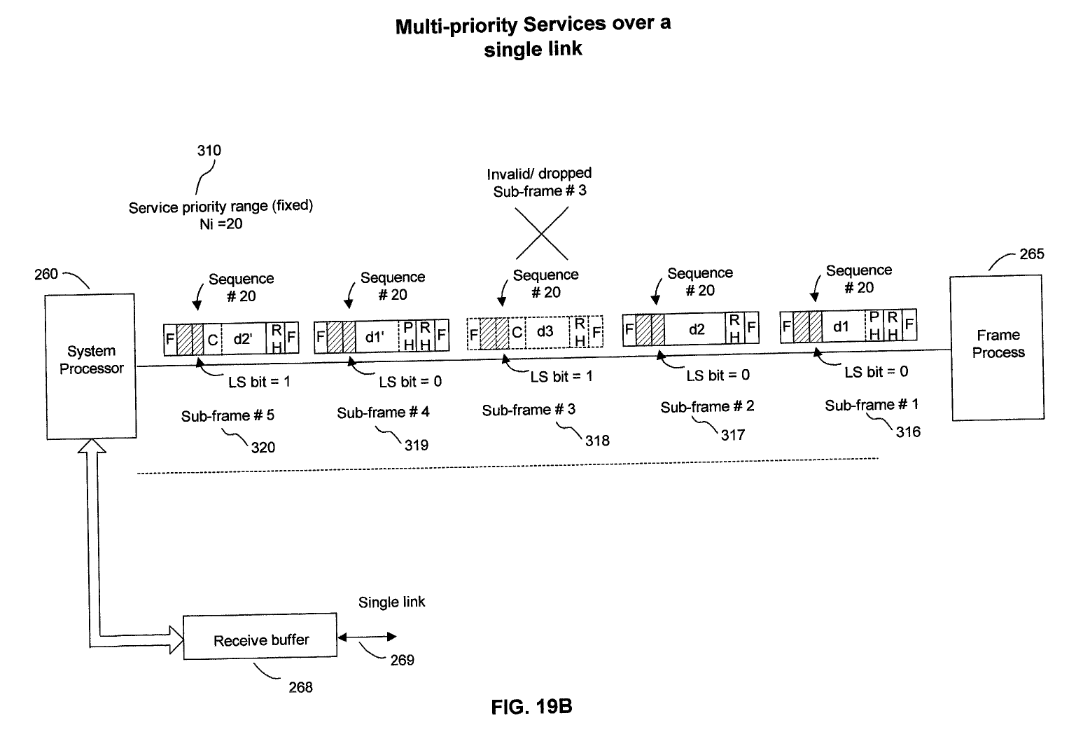

FIG. 19A illustrates an exemplary procedure for assembling and processing received sub-frames for a given service class. Two diverse communication links 267 and 269 deliver the incoming sub-frames to receive buffers 266 and 268 respectively. The buffers 266 and 268 transfer the sub-frames to the system processor 260 for further processing. The system processor 260 identifies the service class and rearranges the received sub-frames in ascending order (if applicable). For illustration purposes, in this example, the sequence range assigned for this particular class is from 20 to 23. This means that the transmitted device for a particular service class labels the sequence range starting from 20 and ending at 23 to all sub-frames transmitted in a round robin, i.e., the next transmitted sub-frame after 23 is assigned a sequence number of 20 again. The first frame transmitted by the sending device is segmented into three sub-frames. These three sub-frames are received by a receiving device as a series of three sub-frames 311, 312, and 313. Each said sub-frame is carrying the d1, d2, and d3 portion of the data of the original transmitted frame.

As shown in the FIG. 19A, the sub-frame 313 is either lost during the transmission or has been received as an invalid sub-frame. In both cases no useful information about the d3 portion contained in the sub-frame 313 can be extracted and the sub-frame 313 is dropped. The service algorithm recognizes this loss of the sub-frame in step 297 as illustrated in FIG. 18. Since the essential segment of the original frame had been lost the remaining two sub-frames 311 and 312 can not reproduce the information as transmitted in the frame. As a result, the service algorithm proceeds to discard all the sub-frames in the buffer (sub-frames 311 and 312). This action corresponds to step 298 of the service algorithm in FIG. 18. After discarding the data it proceeds with the assumption that the sub-frame 314 is the beginning of the new frame. The assigned sequence to the sub-frame 314 is 23 which is the last sequence number in the service class. The service algorithm accept to receive the next sequence number which is rolled back to service first assigned number, i.e., 20. The LS bit value in the last sub-frame 315 is set to 1 implying that the said sub-frame contains the last segment of the frame. The field labeled as C in the sub-frame 315 (FIG. 19) represents the original 2-bytes CRC of the transmitted frame. The 3-bytes trailing overhead (2-bytes sub-frame CRC & 1-byte for sub-framing) are removed from each of the sub-frames 314 & 315. The data portion d2′ of the sub-frame 315 is annexed with data portion d1′ of sub-frame 314 to construct the original transmitted frame. The CRC is calculated on the assembled frame and is compared with the original frame transmitted CRC value. If a successful match is found then this implies that the service algorithm assumption was true to “guess” sub-frame 314 as the start of a new frame. On the other hand, if the CRC does not match then this means either sub-frame 314 was not the start of a new sub-frame as assumed or potentially the data in either sub-frames 314 or 315 had been corrupted. In both cases the assembled frame is discarded.

FIG. 19B illustrates the same example as described in FIG. 19A. It covers a scenario where each individual service class is identified and represented by a single assigned sequence number. To use this scheme the only requirement is that the sequence order of the transmitted sub-frames between the sending and the receiving devices must be preserved. A single communication link existing between the sending and the receiving devices guarantees to satisfy this requirement. Since there are no unique sequence numbers assigned within a service class the system processor cannot rely upon recognizing a pattern of sequentially ascending number of the received sub-frames to ensure proper reception. The presented technique uses a different approach to identify if a sub-frame belonging to a particular service class is lost during the transmission. The system processor starts with an assumption that the first sub-frame 316 received in the service class buffer contains the initial data segments of a frame. It continues to monitor the LS bit status of all the following received frames. Once it receives the sub-frame 320 with the LS bit value set in the sub-framing byte, it marks this particular received sub-frame as the last sub-frame. Identifying the last two data bytes prior to the sub-framing byte position of the last sub-frame, 320, as the original CRC bytes of the transmitted frame, it constructs the original frame as described in conjunction with FIG. 8. The system processor then checks the resulting CRC value with the transmitted CRC value of the frame. Since the sub-frame 318 has been lost during the transmission the resulting CRC will not match with the original CRC (C field of sub-frame 320).

At this point the system processor can conclude that a single or multiple sub-frame is missing but it does not know which one and how many sub-frames are missing. Also, it cannot determine if the missing sub-frame contained an intermediate data segment of the present frame or if it contained the last segment of the present frame (like in this case sub-frame 318 being the last sub-frame). It may not be a productive approach to discard every sub-frame in the service buffer. This can lead to the discarding of a perfectly fine frame being contained in the sub-frames 320 and 319. To extract this said frame without discarding it, the system process utilizes a simple method. It proceeds with the assumption that the sub-frame #5, 320 could be by itself a complete frame and checks the CRC match. Since sub-frame #5, 320 is not a complete frame the CRC verification check fails. Next, the system processor assembles the sub-frame #5, 320 and sub-frame #4, 319 to verify the CRC. The CRC will match and the resulting frame is transferred to frame process 265. In a situation where the potential missing sub-frame is further down, the system processor 260 continues to assemble the available sub-frames in the buffer to produce a frame and verify the CRC until it reaches the first received sub-frame in the service buffer. If this occurs then it confirms that the missing sub-frame contained the intermediate segment of the data and as a result the entire service buffer will be flushed. The above scheme presents a very productive solution in an environment where numerous service classes need to establish a priority hierarchy with few sequence number ranges available to define priority classes.

The following section describes some of the applications that can be materialized using the functionality of the preferred embodiment.

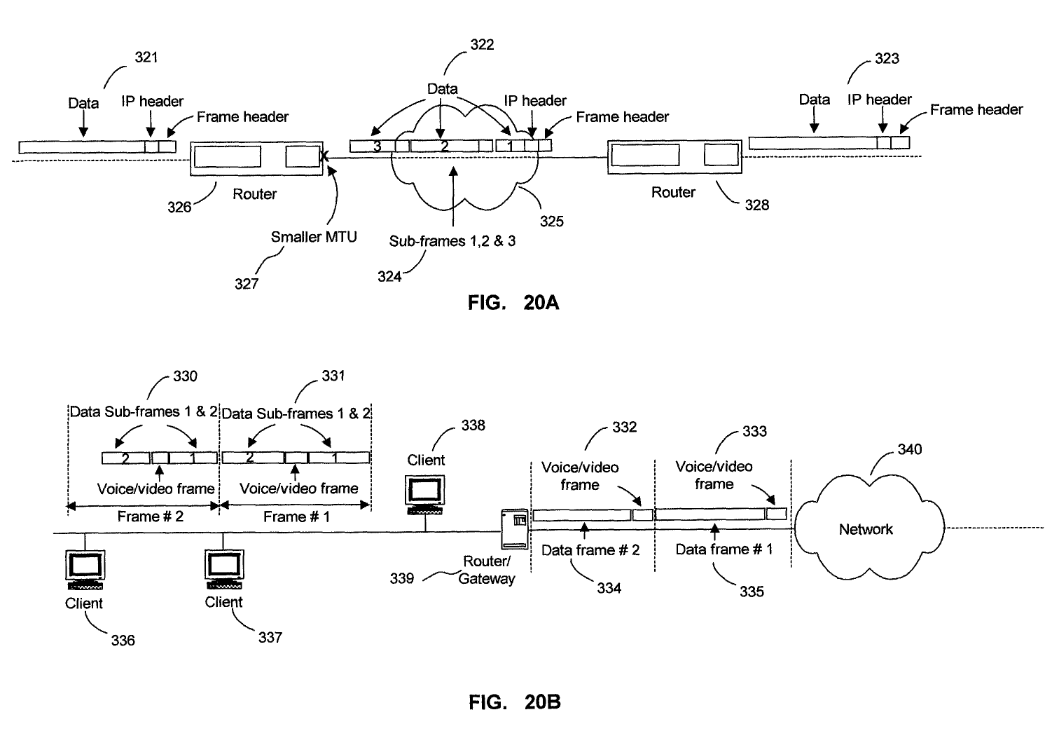

FIG. 20A elaborates on one of the exemplary implementations of the present invention. In a typical IP based network (e.g. Internet) routers are configured to handle a Maximum Transmission Unit (MTU) and in basic terms, it defines the maximum size of a packet that can be transferred in one frame over a network.

In the IP world if a router receives an IP datagram that is bigger than its MTU value configured for the egress port, it invokes the IP fragmentation procedure provided the DF bit in the IP header is not set. During the IP fragmentation process the received IP datagram is divided into smaller units of IP datagrams which are equal or less than, in byte size, to the permitted MTU of the interface. The fragmentation procedure for an IP datagram is not only processing intensive but also replicates the IP overhead (20 bytes) to each IP fragment carrying a segment of the original IP datagram. IP is a layer 3 protocol and needs to be carried over a data link protocol, e.g. PPP, Frame Relay, HDLC, etc. Using the preferred embodiment, a received IP datagram can easily be fragmented at the data link layer into multiple sub-frames. Each sub-frame can carry a maximum number of bytes allowed by the MTU of the interface. This will result in much lower overhead bytes as compared with the IP fragmentation process and also it increases the efficiency of the device.

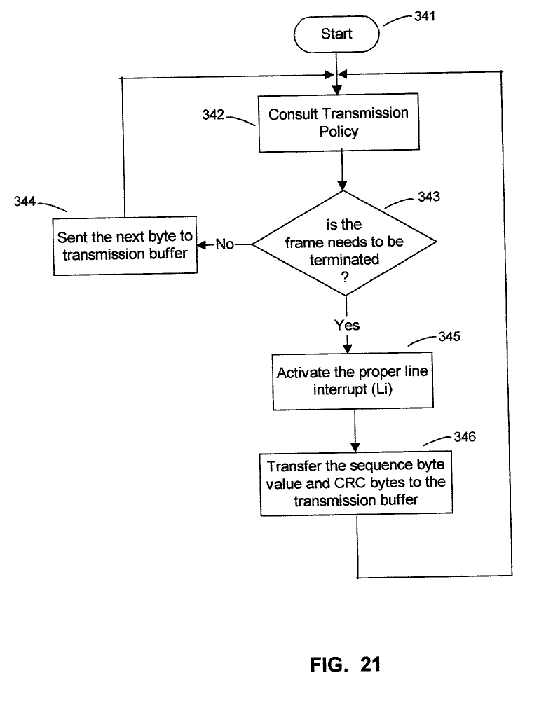

Referring back to FIG. 20A, a large IP datagram 321 encapsulated in a data-link frame is received at the ingress port of the router 326. The router 326 is configured to transmit a smaller MTU at the egress port than the received IP datagram. FIG. 21 presents the algorithm that can be used to fragment the large IP datagram into smaller size data link sub-frames. In step 342 of FIG. 21, the system processor consults the transmission policy which includes the MTU size availability to decide if a received data IP datagram needs to be fragmented. If so, as determined by the decision box 343, it activates the line interrupt (Li) after transmitting the data bytes allowed by the MTU in step 345. At this point the corresponding CRC and the sub-framing bytes properly calculated for the sub-frame are transferred to the transmission buffer. These three bytes are appended after the sub-frame data bytes for transmission. After executing step 346 the control goes back to the start 341 for the next desired fragmentation.

Using this fragmentation procedure the IP datagram 321, as shown in FIG. 20A, is segmented to three individual sub-frames 322. Only the first sub-frame carries the original IP header, thus reducing the unnecessary IP overhead in the second and third sub-frame. It should be noticed that it is not required for the sub-frames to follow the same one path to reach to the destination router 328. As similar to the IP network if multiple data link networks are available between the source router 326 and the destination router 328 the sub-frames can take any available paths to get to the destination. As discussed earlier, with reference of FIG. 13B dissimilar networks can have variable bandwidth and delay characteristics. This can result in a situation that the transmitted sub-frames may arrive out of sequence at the final destination. To reduce this possibility, each sub-frame needs to carry a unique sequence number that cannot be duplicated in the incoming stream of sub-frames from other alternative links. As described in the preferred embodiment of the invention, 7-bits assigned in the sub-framing byte can generate 127 unique sequence numbers. Each transmitted sub-frame is assigned an incremental sequence number until it reaches the last sequence number 127 and then it rolls back to the first sequence number. The receiving device 328 rearranges the train of the received sub-frames coming from diverse links and puts them into proper sequence order. Using the procedures described earlier, it assembles the correct number of sub-frames to reproduce the original IP datagram 323. If the delay characteristics of dissimilar networks warns a higher sequence number then the two bytes can be reserved for sequence numbering as described in reference of FIG. 4B.

FIG. 20B yet illustrates another powerful application of the preferred embodiment. Shown here are three multi-media client stations 336, 337, and 338 interconnected through a LAN topology. Client 337 starts to transmit a data-frame #1 (331) on a LAN connection, e.g., Ethernet link. During the course of its transmission, a higher priority service frame e.g., a voice video frame, becomes ready for transmission. As a result, the client 337, equipped with the present embodiment, interrupts the transmission of data sub-frame #1 (331) by appending the necessary CRC and sub-framing bytes. It then starts to transmit the high priority multimedia frame. Upon completion it resumes the transmission of the remaining portion of the data frame contained in the sub-frame #2 (331). When the router/gateway 339 receives the first data sub-frame #1 331, it reads the framing byte, recognizes that it is not a complete frame, and it holds the sub-frame into its buffer. Following the first data sub-frame 331, the voice/video sub-frame arrives at the router gateway 339. The router/gateway 339 recognizes that the voice/video frame is a complete frame and it starts transmitting the frame to its WAN interface. Upon receiving the second sub-frame #2 (331) the gateway 339 reassembles these two sub-frames to reproduce the original transmitted frame. After transmitting the video-voice sub-frame through its WAN interface, gateway 339 starts to transmit the data frame #1, 335, to its WAN link. As illustrated in this application even though the voice/video sub-frame was transmitted by interrupting the transmission of the data frame, it is transmitted ahead of the data frame at the WAN link. In other words, this preferred embodiment provides a way that can seize virtually all the available link bandwidth in real time for a higher priority service, not only on the LAN side, but also on the WAN side of the network. Higher priority traffic is prioritized in such a way that it can virtually utilize all the available link bandwidth at any time it demands.

As mentioned earlier, the proposed system and method can be implemented in either a software or hardware configuration. If the software application for the proposed system and method is installed on a device then the said device ensures that the transmitted outbound traffic, which may consist of plurality of multi-priority services, always complies with certain priority levels uniquely assigned to an individual class of service. If the proposed system and method is implemented in the hardware version then the resulting hardware device called the Intelligent Multi Priority System (IMPS) can perform the same functionality. This standalone piece of hardware (IMPS) can be interfaced with the egress port of any data link device which delivers the data link frames. The IMPS accepts the data-link frames containing multi-priority services at its ingress port in the native data link layer format and transmits the said frames with assigned priority levels through its egress port.

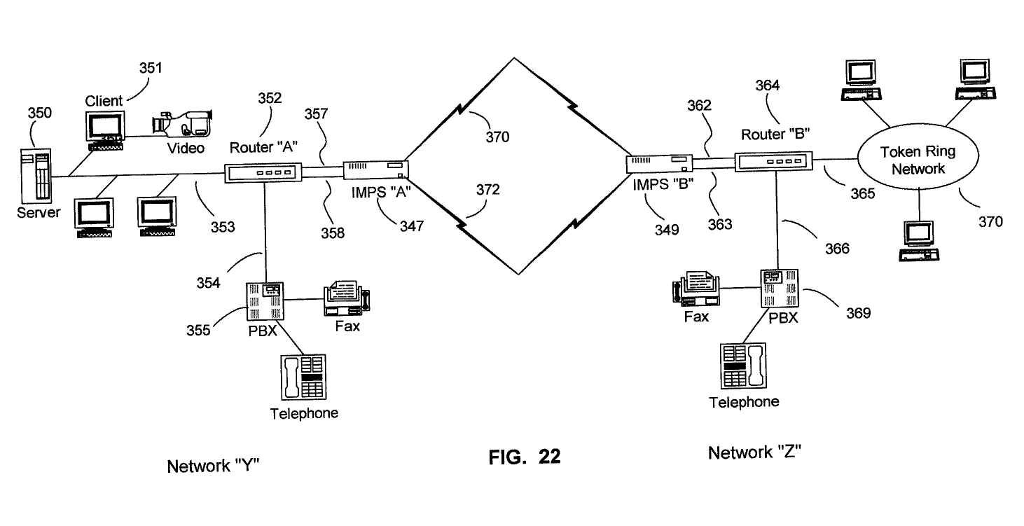

FIGS. 22 to 25 illustrate the IMPS implementation in either a hardware or software configuration with reference to different network scenarios. As shown in FIG. 22 the Router ‘A’ 352 in Network ‘Y’ is connected to a server 350 through a typical data link interface 353, e.g., Ethernet interface etc. A video source is attached to one of the clients station, Client 351, which directly receives the video information from the video source. After processing it into a desired format the Client 351 delivers the video information to the attached LAN segment 353 which transmits video traffic to the Router ‘A’ 352. The Router ‘A’ 352 is also capable of supporting voice services through priority data link frames, e.g., voice over Frame Relay (FRF.11 standard), and is connected to a PBX 355 through a trunk interface 354. The IMPS ‘A’, 347, interfaces at the egress port of the Router ‘A’ 352 through dual links, i.e., a low priority link 357 and a high priority link 358. Using the first link 357 the Router ‘A’ 352 delivers the low priority traffic (data traffic) to IMPS ‘A’ 347 while the second link 358 delivers the high priority traffic (e.g., multimedia traffic) in the native data link format (e.g., Frame Relay) to the IMPS ‘A’ 347. Using the techniques and methods already proposed in reference to the present invention the IMPS ‘A’ 347 identifies and prioritizes the outgoing frames representing different service classes. The System Transmission Policy Algorithm (SPTA), as explained earlier, which is implemented in the architecture of the IMPS determines the transmission policies and bandwidth allocation for each of the data link frames being transmitted over the attached WAN interfaces 370 and 372. As described with reference to 7A & 7B, the IMPS ‘A’ 347 supports the cut-through mechanism and, thus, delivers the low priority or high priority frames to the WAN interface (dedicated communication links) as soon as it receives the frame without incurring any delay. During the course of transmission of a low priority frame if the IMPS ‘A’ receives any data link frame on the high priority link 357, the SPTA terminates the ongoing transmission of the low priority data link frame on the WAN links 348 by appropriately inserting the proper value of the sub-framing byte followed by the CRC bytes. As the high priority frame completes its transmission the SPTA resumes the transmission of the low priority frame in real time. The functionality of the IMPS ‘A’ 347 ensures that this procedure fully utilizes all the available bandwidth of the WAN links (370 and 372) in real time according to the description as outlined with reference of FIGS. 13A & 13B.

The peer IMPS ‘B’ 349 in the Network ‘Z’ receives the frames through the communication links 370 and 372. The IMPS ‘B’ 349 properly identifies the service class of each frame through the sequence range values being carried in the sub-framing byte. If a received frame is fragmented as indicated by the sub-framing byte then the IMPS ‘B’ 349 waits for the other sub-frames to be arrived and then reassembles the frame as well. Once the destination egress interface, i.e., 362 or 363 for each of the received service class frames is identified then the sub-framing byte is removed from the individual frame and the corresponding 2-bytes CRC value is recalculated and appended before the ending flag of the frame. The resulting frames are delivered to the corresponding low priority 362 and high priority 363 interfaces. The Router ‘B’ 364 identifies the service class of the individual received frame through its DLCI number. The data frames are redirected to the Token Ring network 370 after properly processing the frame format. Similarly, the voice traffic being carried over the voice frames will be delivered to the PBX 369 through interface 366 by the Router ‘B’ 364. As described earlier, the entire procedure performed by the IMPS devices is completely transparent to the routers at both ends.

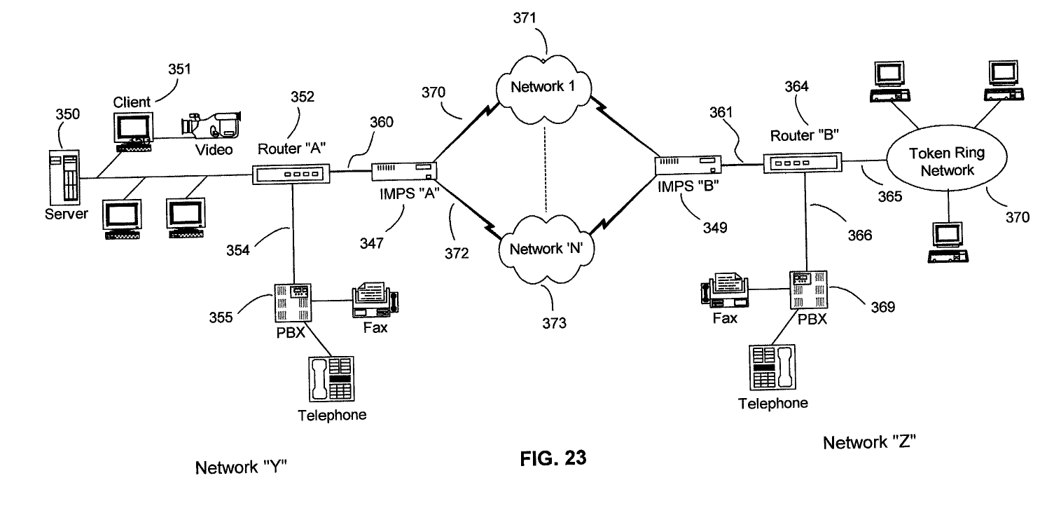

FIG. 23 illustrates a different network scenario where IMPS devices are connected through a plurality of data link networks, e.g., frame relay network, PPP network, etc. Instead of separate multi-priority links, the Router ‘A’ 352 interfaces with the IMPS ‘A’ 347 through a single HSI 360 (High Speed Interface). The Router ‘A’ 352, for example, delivers both the low priority and the high priority data link frames at a very high speed through the use of HSI 360 to the IMPS ‘A’ 347. Since the multi-priority frames are transmitted by the Router ‘A’ 352 over a single HSI link 366, the IMPS ‘A’ 347 needs a scheme that can differentiate the individual priority service class within the received frames. Generally, the header of a typical data link layer frame contains reserved fields that can be used to uniquely identify the type of traffic being carried by that particular frame. For instance, if the HSI link 360 is configured to carry frame relay traffic the Router ‘A’ 352 and IMPS ‘A’ 347 can be mutually configured to identify the multi-priority frame relay traffic based on a set of pre-assigned DLCI numbers.

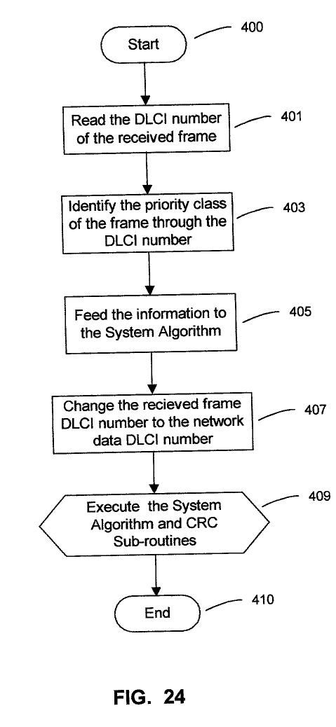

FIG. 24 shows a flow chart that describes the top level operation of the IMPS system algorithm that is used to identify a frame relay service class based on the DLCI number. Illustrated as an initial step 401 the algorithm reads the DLCI value of an incoming frame. Step 403 properly identifies the priority service of the frame through the DLCI number. Once the frame priority class is identified this information is sent to the System Algorithm as indicated in step 405 which determines and dictates the transmission behavior of the received frame associated with a certain service class. As mentioned earlier, the sub-framing byte value uniquely determines the priority service of the frame. The System Algorithm matches the priority level of the frame being defined by the DLCI number to the proper sequence range assigned for the particular frame priority. Since the information transmitted in the sub-framing byte is sufficient to identify the service class of a frame it is possible to use only one DLCI number for all Frame Relay frames being transmitted to a particular location in a given Frame Relay network. The Frame Relay providers usually charge a customer based on the number of PVCs being utilized in a Frame Relay network. It should be noted that each PVC is uniquely identified by a DLCI number. There are a number of schemes described in the technical literature that identify different data service classes by using different DLCI numbers (PVCs) in a Frame Relay network. For example, voice and data services being transmitted over a Frame Relay network are identified through two or more PVCs. In this regard, the preferred embodiment provides a way to use only a single PVC to transport multiple types of service classes through a Frame Relay network between a specific source and a destination. This method can significantly reduce the total cost for the customer being incurred by using multiple PVCs to carry multiple classes of services to the same destination. As illustrated in step 407 of FIG. 24, the different DLCI numbers carrying multiple service class frames are changed to a single DLCI number. It should be noted that the DLCI numbers typically used for signaling and management purposes (e.g., DLCI 0 & DLCI 1023) remain unchanged. Step 409 executes the System & CRC sub-routines as described in reference of FIGS. 15A and 15B to determine the transmission priority of the frames.

Referring back to FIG. 23, the IMPS ‘A’ 347 delivers the frame relay traffic to the Network 371 over the link 370 and to the Network 373 using the link 372, respectively. As previously discussed with reference to FIGS. 13A and 13B the IMPS ‘A’ 347 has the ability to utilize both networks (Network 372 and Network 373) simultaneously to deliver the frame relay traffic in any byte proportion.

The IMPS ‘B’ 349 in Network ‘Z’ receives the frame relay traffic from both networks (Network 371 & 373) and uses the sub-framing byte information to reassemble the received sub-frames, if necessary, and also to identify the proper priority class of the received frames. Using this information it consults the built-in system table to match the pre-defined DLCI number with each of the priority class frames. Once a proper match is found, the system algorithm changes the DLCI number in the received frame header to reflect the associated frame priority class. In addition, the said algorithm also removes the sub-framing byte and recalculates the frame CRC as described earlier. The Router ‘B’ 364 relies upon the distinct DLCI number information of each of received individual frames to properly determine the destination of the data traffic. For example, if the Router ‘B’ 364 is using a voice over frame relay standard it processes the received voice frames and delivers to the PBX 369 in a proper format via the link 366. Similarly, the data frame received by the router as identified by the frame relay DLCI number is processed and delivered via the link 365 to the Token Ring 370 or any other network in the right native format.

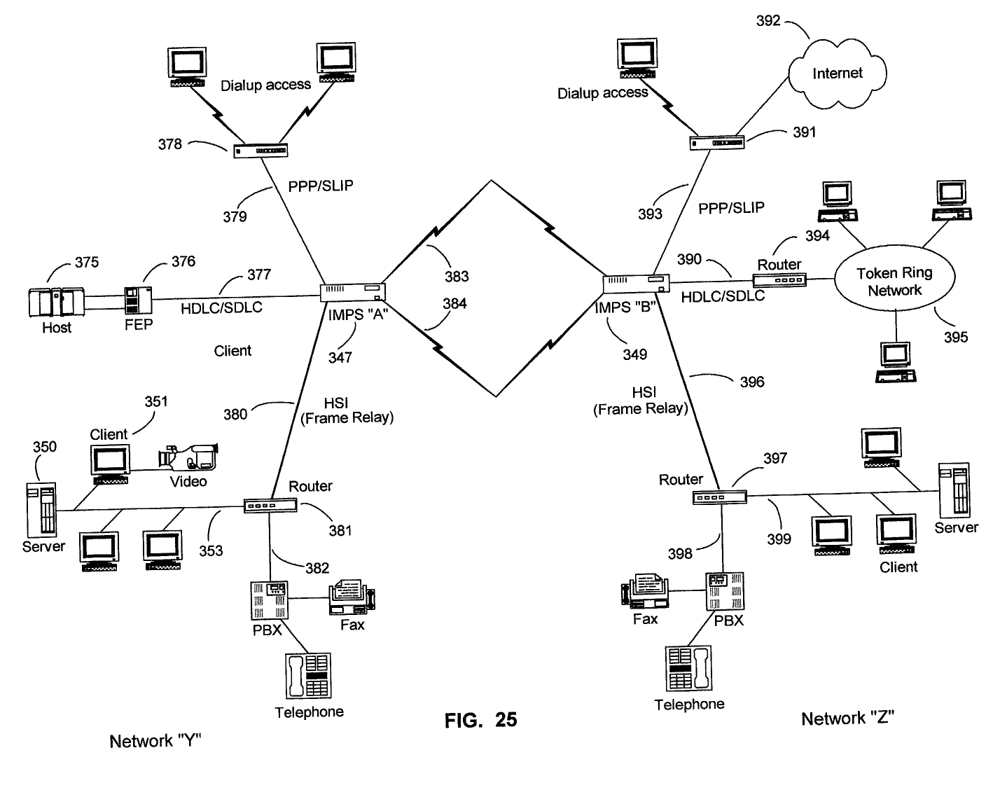

FIG. 24 presents another very versatile application of the proposed method and system. As mentioned earlier, a typical WAN data link layer frame is identified by opening and ending flags. Following the opening flag, the header of a frame contains the information that defines the type of the data link layer protocol. Since the functionality of the preferred embodiment utilizes flags as demarcation boundaries for any type of data link layer frame it is not dependent on the header information that determines and defines the type of data link layer frame. This implies that a diversity of dissimilar data link layer protocols can coexist concurrently on the same physical transmission link as long as the inserted sub-framing byte can uniquely identify a data link frame type. An application program tailored to operate on a preferred choice of a data link layer protocol can coexist with other application programs utilizing a different set of data link layer protocols on the same physical layer transmission medium. Referring back to FIG. 25, the illustrated network topology presents a variety of network elements configured to operate at different data link layer protocols. As shown, a remote user dials into the communication server 378 to access the IMPS ‘A’, 347, located in the Network “Y” through PPP/SLIP choice of data-link layer protocol. A SNA host 375 interfaces with a Front End Processor (FEB) 376 which communicates with the IMPS ‘A’ 347 through HDLC/SDLC suite of protocols over the link 377. Another set of network elements present in the Network “Y” is consisted of LAN, video, and voice components. A multimedia Router 381 interfaces with these network components. The said Router converts the received traffic into proper frame relay format and then delivers the resulting frame relay frames to the IMPS ‘A’ 347 over the attached High Speed Interface (HSI) link 380.

The system algorithm implemented in the IMPS ‘A’, 347, determines the priority level of each of the data link layer frames being received at each of its ingress interface. The priority level of the received frames can be established on the basis of the attached interfaces by the system algorithm, i.e., interface 379, 377, and 380 in the FIG. 25. This implies that a data link layer frame being received on a particular interface can have a relatively higher priority as compared to other frames being received on the other attached interfaces. Also, as explained earlier with reference to FIG. 23, the data link frames carrying multi-priority traffic on the same interface can also be relatively prioritized through the use of any distinct information embedded in their data link layer headers. For example, the multi-priority frame relay traffic being transmitted over the HSI link 380 can be relatively prioritized on the basis of the DLCI number of the individual frame. As explained in conjunction of FIG. 4A, the IMPS “A” sets aside a unique sequence range of the sub-framing byte for each of the data link layer frames being received at the plurality of the interfaces. Using the same methodology, the IMPS ‘A’, 347, inserts the proper sub-framing byte during the processing procedure of every received data link frame before it transmits the frame over single or multiple physical layer links 383 and 384. It should be noted that the IMPS ‘A’, 347, does not modify any information being carried in the header of a frame as it processes the frames. The transmission characteristics including the priority of the transmitting frames are being enforced and monitored by the SPTA as explained earlier. The bandwidth utilization and distribution of transmission links 383 and 384 for the data link frames is controlled and monitored by the SPTA with a granularity of a single byte, if desired.

The IMPS ‘B’, 349, receives the frame transmitted by the IMPS ‘A’, 347 through the links 383 and 384. During the processing procedure it reassemble the frames, if necessary, identifies the frame service class through reading the sub-framing byte information and eventually delivers the frame to the corresponding interfaces, i.e., 390, 393, and 396. Since during the frame processing and the transmission the header information of each of the data link frame is intact the identity and the type of the every frame is also preserved. The IMPS ‘B’ 349 delivers the PPP/SLIP frames to the access server 391 through the link 393 which can be connected to a dial-up user or to the Internet 392. The HDLC/SDLC frames are forwarded to the Router 394 which may convert the data link format to Token Ring and deliver it to the attached network 395. The IMPS ‘B’ 349 also delivers multi-priority service frame relay traffic being distinguished through unique DLCI numbers (PVCs) to the HSI link 396. The multimedia Router 397 receives the frames and based on their DLCI number processes the frame relay traffic. The said router redirects the resulting traffic into the proper format to the respective attached interfaces as discussed with the reference to FIG. 23.

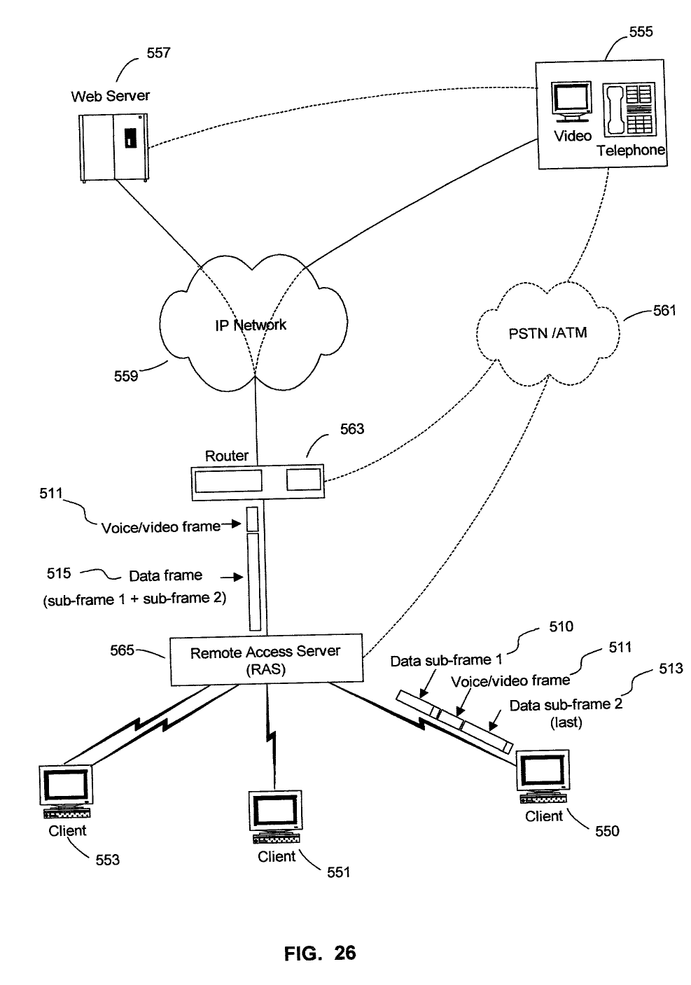

The preferred embodiment yet provides in FIG. 26 another application that can be effectively used in live interactive web site access with real time multimedia services. Since the present scheme can provide a real time priority to voice/video service over data, the user interaction with the web site contents can be very effective. FIG. 26 illustrates a high level network architecture that is used to communicate between a plurality of clients, 553, 551 and 550 with a Web server 557. To access the Web server 557 these clients establish a data link layer connection to the Remote Access Server (RAS) 565. After proper user authentication the access is granted to the Web server 557. Using the multi-priority services scheme presented in this invention only the clients (553, 551, and 550) AND the RAS 565 needs to be locally aware of this implementation. The data link frames that are transmitted by the RAS 565 to the Router 563 are the standard data link frames in their native formats. For illustration purposes the client 550 establishes a data connection with the web-server 557. If a user desires to establish a live interactive session with a live representative who is present at a multimedia terminal 555, the user initializes a built-in graphical interface at the client station 550. Once the interactive session is launched the appropriate voice/video frames are transmitted by the client 550 as a higher priority traffic in order to establish an interactive connection with a live representative present at the multimedia terminal 555.

During this interactive multimedia session establishment the user's present http web-site address information is transferred to the multimedia terminal 555. Upon the user's request the live representative at the multimedia terminal 555 responds to the user's interactive request, and as a result a live multimedia session is established between the representative and the user. The multimedia terminal 555 uses the user's present web-site address to fetch the same web page information from the web-server 557. At this time, the live representative at the multimedia terminal 555 looks at the same web-site page information that is displayed at the client 550 web interface. The user at the client 550 may inquire the information of interest from the live representative on the multimedia connection. As a response to the user's request, the live representative at multimedia terminal 555 navigates the requested information on its own displayed web-site page by clicking single or multiple interactive hyper-links on the page. The information is fetched from the web-server 557 and is displayed on video/voice terminal 555. As the live representative finds the desired information it directs the hyper-link information (web-site address) to the client 550. The client 550 in turn establishes a data connection to the web-server 557 to fetch the contents of conveyed hyper-link directly from the said web-server 557. Once client 550 successfully receives the web-site information from the web-server, it notifies multimedia terminal 555 about the successful completion of the web page. At this time, the live representative knows that the client has the same web page as displayed on the multimedia terminal 555. An interactive inquiry can be made by the live representative to confirm that they are on the same web page. At this point the user can interact with the live representative over the multimedia connection to obtain any particular desired information or execute any transactions.

FIG. 26 also illustrates some other viable options that can be used to access the multimedia terminal 555 in real time. As the client 550 starts to transmit data sub-frame #1, 510, the said sub-frame is interrupted by the high priority voice/video frame 511. After transmitting the voice/video frame 511 the client 513 resumes the transmission of the remaining data in sub-frame 513. In accordance with the procedure as described in reference to FIG. 20B, the RAS 565 transmits the voice/video frame 511 before data frame 515. Once the voice/video frame is prioritized there can be multiple choices to send the said service frames to multimedia terminal 555. One option is to utilize a better real time network, e.g., PSTN or ATM, over the sluggish IP network for faster transmission of only the voice/video service frames. The data frames can be carried by IP network. To implement this scheme either RAS (565) or the router (563) can isolate the multimedia traffic from the data traffic and then redirect this traffic to PSTN/ATM network, 561 in order to deliver the traffic to the multimedia terminal 555. If this option appears to be cost prohibited then the voice/video traffic can be carried over the IP network to reach to the destination 555.

Normally, the bandwidth bottleneck for voice/video traffic occurs between a remote client and the first device in the network, e.g., RAS. Since the present invention provides an inherent priority to interrupt the long data frames being transmitted, it can cut down the queuing and serialization delays for the time sensitive frames. The major source of the queuing delay comes from the fact that the time sensitive frames have to wait behind a long data frame until it finishes its transmission. Since a long data frame can be interrupted ‘on a fly’ the queuing and serialization delays can be insignificant for the high priority traffic. Conventionally, when the data traffic is mixed with the multimedia traffic the commonly used segmentation methods tend to impose a maximum data frame size limit to avoid long queuing and serialization delays resulting from the transmission of long data frames. This technique does not require or encourage any restriction on the data frame size for transmission when mixed with multimedia traffic.

Another feature that can be provided by this invention is to redirect a phone call being originated through a PSTN network to a user in the event the connecting link is being used for Internet access. The majority of the Internet users still rely upon modem access for dialing out to a RAS through telephone lines. Even though the Internet has become very popular, still most of the users have only one single telephone line installed at their homes which is utilized for both purposes. During the Internet web sessions the majority of phones calls are missed. The preferred embodiment can also be used to present a very practical solution to this problem. In the event a PSTN switch receives a busy signal from a user site which probably means that telephone line is being used for the Internet access, the incoming telephone call is redirected to the user's logon RAS by the PSTN switch. Once the call is received by the said RAS, after proper identification, it converts the contents of the voice call into prioritized data link voice frames in accordance with the description of the preferred embodiment. It should be noticed that the same technique can be used by the user to make outgoing phone calls while still surfing on the Internet. In the event a phone call needs to be made the client station converts the voice call contents to proper data link frames and forwards these priority frames to the logon RAS. The RAS changed the framing format and hands over the voice call to the PSTN switch for further processing and distribution.

The preferred embodiment can also boost the available bandwidth by simultaneously utilizing the multiple telephone lines to a RAS. Many users have acquired two telephone lines, one being used for Internet access and the other tends to remain as a standby line for telephone calls. The scheme as described in reference to FIGS. 13A and 13B where both links can be simultaneously used. It should be noticed in accordance with the spirit of the invention any number of diverse data link networks can be used to augment the bandwidth available to a user. In FIG. 26, the client 553 has two available links to the RAS 553, and as described in accordance with the methods presented, the client 553 can use data link frames identified by sequence numbers to utilize both links simultaneously. While using both access lines for Internet access, any incoming telephone call or fax can be redirected to the logon RAS 565. As described earlier, RAS 565 can encapsulate the call information into priority data link frames and can forward these frames to the client 551. Using this approach a user can utilize both access lines simultaneously to maximize the data throughput as well as receive the phone calls at the same time.

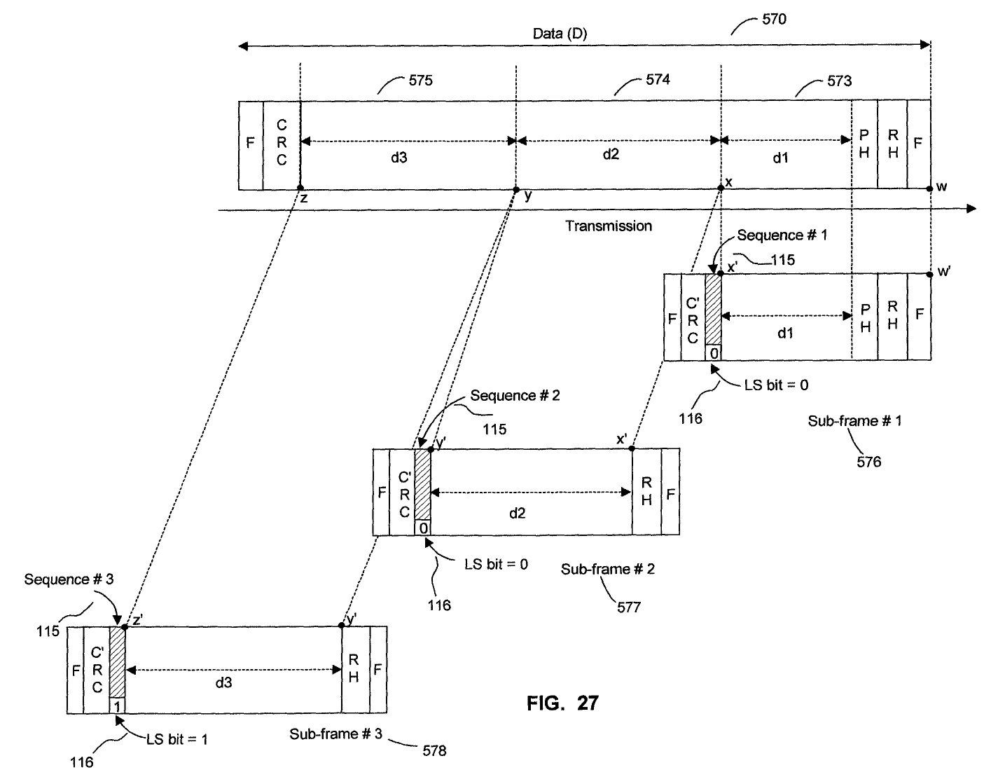

FIG. 27 illustrates an alternative scheme to segment a data link frame into multiple sub-frames. The frame header and the data of the original frame 570 is segmented into three sub-frames of different sizes 573, 574, and 575. The resulting sub-frames 576, 577 and 578 contain the data segments 573, 574 and 575, respectively. In this scheme the CRC of the original frame 570 is not included in the last sub-frame. Each sub-frame carries its own CRC that validates the integrity of the contents of only that particular sub-frame. The logic behind this approach is that if all the received sub-frames are received with a valid CRC then the original transmitted frame can be reassembled from the received sub-frames. In the event a frame does not need to be segmented then this scheme adds an overhead of only one extra byte (sub-framing byte). The original CRC bytes of the frame are recalculated and are appended after the sub-framing byte to reflect the integrity of the entire frame.

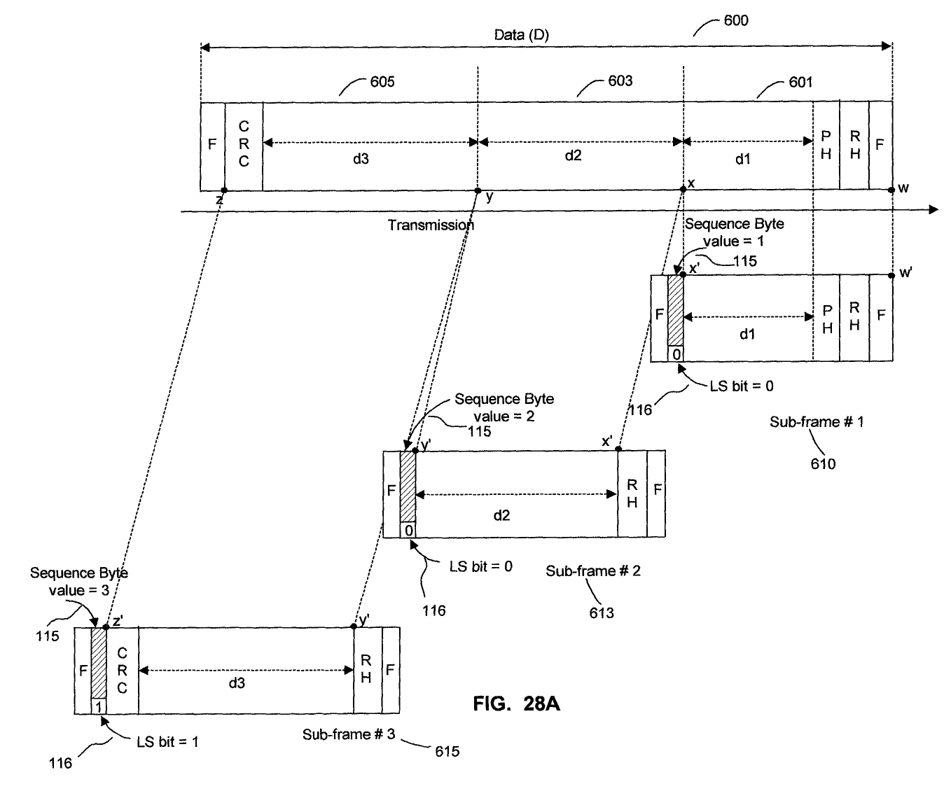

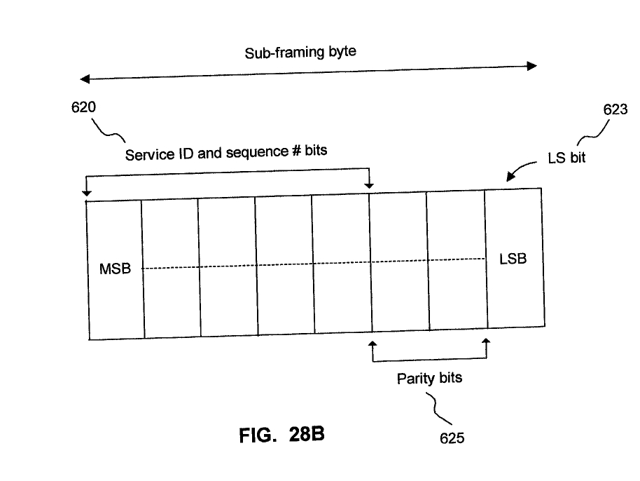

FIG. 28A yet represents another illustration that can be used in a situation where the low overhead resulting from the segmentation of a frame into sub-frames is desired. This situation usually arises when low speed links are used for data link frame transmission (e.g., telephone lines). To implement this scheme the requirement is that the receiving data link device is programmed not to calculate the CRC of an individual sub-frame unless all the sub-frames belonging to the original transmitted frames are received and assembled. Referring back to FIG. 28A a frame 600 which needs to be segmented into smaller multiple sub-frames is shown. For illustration purposes only three sub-frames are presented here to describe the segmentation procedure. The illustrated scheme can be extended to any number of sub-frames. The first segment of the frame w-x, 601 is mapped to the w′-x′ portion of the sub-frame #1, 610. The said sub-frame contains the initial d1 portion of the data bytes of the frame 600. Following the last data byte of the d1 segment, the sub-framing byte is inserted. Similarly, the data portions in the remaining two data segments 603 and 605 are mapped into sub-frames 613 and 615, respectively.

As described earlier with respect to FIG. 2 the sub-framing byte consists of two portions, 7-bit sequence part and 1-bit Last segment (LS) bit. Following the sub-framing byte is not the CRC bytes of the sub-frame but the ending flag (7E hex). The sequence value 115 of the sub-frame #1 corresponds to the first designated sequence number of the sequence range assigned for a particular service class. Since more sub-frame are to follow, the LS bit value is set to 0. The next sub-frame #2, 613 contains the d2 segment of the frame 600. The associated sub-framing byte of the said sub-frame contains the next sequential sequence number of the service class with the LS bit value set to 0. The third sub-frame #3, 615 contains the last segment, d3, of the frame 600 and following the last byte of the d3 segment are the original CRC bytes of the frame 600. Since the sub-frame #3, 615 contains the last segment the LS bit value in its sub-framing byte is set to 1. At the receiving end the data segment contained in each of the sub-frames is assembled together. After receiving the last sub-frame as indicated by its LS bit value in the sub-framing byte the CRC value is calculated on the entire frame. If the CRC matches, the frame is delivered to the frame processor, otherwise, the frame is discarded.

As it can be seen from the description of the aforesaid scheme, there is no frame integrity check procedure for the individual received sub-frames. An individual sub-frame will always be accepted by the receiving end regardless of the number of errors occurred during its course of transmission. Only when the last sub-frame is received the CRC check is executed to verify the integrity of the entire frame. A potential problem may occur when single or multiple bit errors occur in the framing byte. Since the receiver identifies the class of service of an incoming sub-frame through the sequence bits, an error in the said bits can inadvertently transfer the sub-frame to the wrong service class. Of course, this error will be detected at the final CRC check on the frame but this can potentially affect two service frame assemblies. The first one is the service class frame where the received sub-frame is mistakenly delivered and the second one is the service class where the sub-frame is supposed to be delivered but did not get delivered because of the sequence bit errors. Also, if the LS bit value in a sub-framing byte is flipped an inaccurate conclusion can be drawn by the assembling process of the receiving end. To avoid this potential problem it is necessary to have some integrity check on the contents of the sub-framing byte. One way to accomplish this is to reserve one or two bits in the sub-framing byte for error detection. The receiver will use the reserved bit(s) to verify the integrity of only the sub-framing byte.

FIG. 28B shows a proposed structure for the sub-framing byte. The first five bits 620 are reserved for the sequence number being used in the service class ID. The next two bits 625 are reserved for the parity check and the last bit 623 (LS bit) is reserved to identify a sub frame carrying the last segment of a transmitted frame. The parity bits 625 verifies the entire sub-framing byte (8 bits). An incoming sub-frame which has the right sub-framing byte value will only be delivered to the appropriate service class.

What is claimed as being new and desired to be protected by Letters Patent of the United States as follows:

1. A method and system to support customized multi-priority services over any data-link communication layer frame type, comprising steps of:
assigning and reserving a single and plurality of bytes in a predefined location of the data-link layer frame, preferably adjacent to the trailing bytes of a data-link layer frame;
the reserved byte(s) are uniquely identified through a fixed byte(s) distance from the trailing or ending flag of a data-link layer frame;
the reserved byte(s) only contain information pertaining to the operation of the techniques used by the said method and system;
the reserved byte(s) in a data-link layer frame represent sequence numbers such that each sequence number can be associated with a unique priority service class that needs to be transmitted or received over a single or multiple communication links; and
the reserved byte(s) in a data-link layer protocol represent sequence numbers such that a predefined range of sequence numbers can represent a unique priority service class being transmitted over a single or multiple communication links.

2. The method and system according to claim 1, wherein the said method can be used and applied on any data link layer frame consisting of and including:
(a) opening and closing boundaries of a frame are determined by a distinct and reserved flag pattern.
(b) opening and closing boundaries of a frame are determined by a distinct and reserved sync bit or byte pattern.

3. The method and system according to claim 1, wherein the said system calculates and updates the CRC (Cyclic Redundancy Check) value comprising the steps of:
calculating the CRC value dynamically over bytes of a data link frame as it is transmitted including the reserved byte(s) value; and
updating the CRC calculation after transmitting a single or pre-determined number of multiple bytes of the said frame including the reserved byte(s).

4. The method and system according to claim 1, wherein the said system can interrupt and seize, if desired, further transmission of any type of data-link layer frame being transmitted on any single or multiple links at any data-link layer frame byte boundary in real time, the method comprising the steps of:
determining the byte position where the ongoing transmission of a data link layer frame needs to be interrupted;
inserting the reserved byte(s) following the interrupting byte position of the data link layer frame;
inserting the updated CRC value following the reserved byte(s) position; and
inserting the closing flag following the CRC value of the data link layer frame or inserting the sync pattern reserved for closing the frame.

5. The method and system according to claim 1, wherein the said system utilizes a scheme that can transmit data-link layer frames as such that any intermediate data-link layer devices or switches are not required to be aware of the presented scheme in order to pass through the data-link layer frames to another data-link layer device which is aware of presented scheme.

6. The method and system according to claim 1, wherein the said system can terminate the further flow of a data-link layer frame using this scheme at any data-link device. Any further outbound communication from the said data-link layer device to any other data-link device can be in the same or an entirely different data-link format.

7. A method and system to support customized multi-priority services over any data-link communication layer frame type, comprising steps of:
implementing a method and system wherein a customized multi-priority algorithm uses a customized feedback for communication requirements to generate traffic priorities of outgoing data-link layer frames over a single or multiple communication links;
assigning weight parameters to a service class such that the assigned parameters can be static or dependent on other variables;
calculating a defined function value for a service class dynamically that depends on the assigned weight parameters;
granting the transmission rights to a service class with the highest numeric result of the defined function value for a time period until the next calculation cycle is executed; and
controlling the transmission of a frame belonging to a service class on per byte basis or in any other byte proportion by means of recalculating the defined function value repeatedly for an interval equivalent to the transmission time for a single byte on a particular transmission link.

8. The method and system according to claim 7, wherein the parameters included in defining the weighing function that controls traffic priorities among the plurality of the service classes are dynamically linked or time dependent on the network conditions.

9. The method and system according to claim 7, wherein the application specific behavior requirements can be defined in terms of weight parameters as included in a service function such that the data transmission rate for the said application can be dynamically adjusted to meet the application requirements.

10. The method and system according to claim 7, wherein the transmission priorities of data-link layer frames on a per byte basis or any proportion can be statically defined by a user's direct input.

11. The method and system according to claim 7, wherein the said multi-priority algorithm provides a way to dynamically adjust and escalate the priority level of an initially declared low priority service to a high priority level. By using this approach a small portion of low priority traffic can be sent as high priority to avoid timeout sessions and retransmits.

12. The method and system according to claim 1, wherein the said system reserves and pre-assigns the position of a single or multiple bytes in a data link layer frame being transmitted on a single communication link such that certain possible sequence values generated by the reserved byte(s) can be uniquely defined and deterministically represent a service class without the need to identify any additional information enclosed in the data link header of the frames belonging to that particular service class.

13. The method and system according to claim 1, wherein the said system uses a unique sequence number range defined by the reserved and pre-assigned byte(s) within a data-link layer frame being transmitted on a single or multiple communication links such that the assigned sequence range can uniquely represent a distinct service class without the need to identify any additional information enclosed in the data link header of the frames belonging to a particular service class.

14. The method and system according to claim 1, wherein the said system can repeat the assigned sequence number range defined by the reserved sub-framing byte for a particular service class being transmitted over a single or multiple communication links.

15. The method and system according to claim 1, wherein the said system uses a distinct sequence range to represent a unique service class and the sequence numbers within the defined range are used to identify multiple segments of a single frame received by a destination host over multiple links.

16. The method and system according to claim 1, wherein the said system supports a cut-through mechanism for faster transmission of a data-link layer frame through a data-link layer device comprising the steps of:
maintaining the availability status of the outbound link for transmission;
passing through a data link layer frame to the outbound transmission link without incurring any delay as long as the outbound link is available;
interrupting an ongoing transmission of a low priority frame over the outbound transmission link at any byte boundary of the transmitting frame as determined adequately by the System Transmission Policy Algorithm (SPTA); and
start sending a higher priority frame through the outbound transmission link as determined by the SPTA.

17. A method and system to support customized multi-priority services over any data-link communication layer frame type, the method comprising the steps of:
segmenting an outgoing frame into multiple sub-frames that can be transmitted simultaneously over all the communication links available for the transmission of data-link layer frames to a particular destination;
estimating the communication delays of all the available links from a source to a destination for data link layer frames transmission;
segmenting an outgoing frame to the said destination into multiple sub-frames in such a byte proportions that the multiple sub-frames transmitted over diverse communication links reaches to the destination almost at the same time; and
dynamically receiving the feedback about the changing delay characteristics of the network and then dynamically readjusting the individual sub-frame byte size in response to this feedback.

18. The method and system according to claim 17, wherein the said system can modify the data link layer header of the frame to make it compatible with and acceptable to another and different traversing data link layer frame networks.

19. The method and system according to claim 1, wherein the said system can assemble the sub-frames received over a single or multiple communication links, the method comprising the steps of:
identifying the service class by reading the sub-framing byte of a received frame;
in case of multiple received sub-frames, properly assembling them to reproduce the original frame in accordance with the received sub-frames sequence numbers pre-defined for a service class;
removing the sub-framing byte present in each of the individual frame and recalculating the CRC of the frame; and
verifying the calculated CRC value with the received CRC value as appended in the original frame.

20. The method and system according to claim 1, wherein the said system has the ability to handle and accommodate concurrently a diversity of data link layer protocols on the same single or multiple physical layer communication links, the method comprising the steps of:
assigning a pre-negotiated and unique sequence range represented by the sequence byte present in every data link layer frame representing an individual service class;
transmitting the diverse data link layer frames belonging to different set of service classes on the same single or multiple available physical layer communication links;
identifying the start and end of an individual data link layer frame at a receiving end through the flags or the sync bits pattern and not reading any information contained in header of the each of the received data link layer frames;
if necessary, assembling the individual received sub-frames through the sequence number information to reproduce the original frame; and
identifying the service class and type of a received data link layer frame by reading the sequence number contained in the sub-framing byte.

21. The method and system according to claim 1, wherein the said system can be interfaced with a Frame Relay network in a manner that requires only a single DLCI to carry multi-priority services on frame relay frames to a known destination, the method comprising the steps:
identifying all the frame relay DLCIs and associating each of the frame relay DLCI with an individual and distinct service class;
assigning a unique sequence number in the sub-framing byte for the frame relay frames representing each of the individual service classes;
changing all the individual DLCIs numbers identified in the data link header of each of the data frames to only one and single frame relay DLCI number;
identifying each of the individual frame service class at the receiving end by reading the sequence number defined in the sub-framing byte of the individual frame; and
re-mapping the service class identification sequence number to the corresponding DLCI number in the data link header of the frame relay frame.
